(19) United States
(12) Patent Application Publication
(10) Pub. No.: US 2023/0186788 A1
(43) Pub. Date: Jun. 15, 2023

(54) SYSTEMS, METHODS AND APPARATUSES FOR A MANIKIN

(71) Applicant: Prestan Products LLC, Mayfield Village, OH (US)

(72) Inventors: Christopher M. Charlton, Mint Hill, NC (US); Timothy E. Lint, North Royalton, OH (US); Mark Edward Cook, Lakewood Ranch, FL (US); Donald Steele Lydic, Mooresville, NC (US)

(21) Appl. No.: 18/106,419

(22) Filed: Feb. 6, 2023

Related U.S. Application Data
(63) Continuation-in-part of application No. PCT/US21/44846, filed on Aug. 5, 2021.
(60) Provisional application No. 63/061,698, filed on Aug. 5, 2020.

(51) Int. Cl. G09B 23/28; G09B 23/32; G09B 5/02; G09B 23/34; G09B 23/30

(52) U.S. Cl. CPC G09B 23/288; G09B 23/32; G09B 5/02; G09B 23/34; G09B 23/303

(57) ABSTRACT

A CPR manikin is provided. The manikin can have a size and shape of the torso area of a human, including a head and a chest area. The head and chest area can be operatively configured to generally mimic a human head, chest, respiratory and cardiopulmonary morphology. Improvements relate to recording, transmitting and reporting scenario data related to chest compression, breathing parameters, and ease of use.

### CROSS-REFERENCE TO RELATED APPLICATION

This application is a continuation-in-part of International Patent Application Serial No. PCT/US21/44846 filed Aug. 5, 2021, which in turn claims the benefit of U.S. Provisional Patent Application Ser. No. 63/061,698, filed Aug. 5, 2020, the disclosure of each of which are hereby incorporated herein by reference in their entirety.

### TECHNICAL FIELD

Embodiments of the technology relate, in general, to systems, apparatuses and methods for a manikin such as, for example, providing technical solutions for proper CPR training on a manikin.

### BACKGROUND

Manikins for training persons in cardiopulmonary resuscitation (CPR) are known. Manikin can be enhanced with improved features and benefits.

### BRIEF DESCRIPTION OF THE DRAWINGS

FIG. 1 is a perspective view of a manikin.

FIG. 2 is a perspective view of the manikin of FIG. 1 in a compressed state with the upper torso surface in an open position.

FIG. 3 is a cross-sectional perspective view of the manikin in an uncompressed state taken along the line 3-3 in FIG. 1.

FIG. 4 is a cross-sectional perspective view the manikin in a compressed state taken along the line 4-4 in FIG. 2.

FIG. 5 an enlarged sectional view of section 3-3 of FIG. 1 showing the manikin in a compressed state.

FIG. 6 is a perspective view of an example manikin.

FIG. 7 is a schematic diagram of exemplary switch positions of the manikin of FIG. 6.

FIG. 8 is a representative chart of example feedback in a method and system of the present disclosure.

FIG. 9 is a perspective view of an embodiment of the manikin of FIG. 1 with example visual indicators.

FIG. 10 is a schematic representation of an example visual indicator of FIG. 9.

FIG. 11 is a schematic representation of another visual indicator of FIG. 9.

FIG. 12 is a schematic representation of the visual indicator of FIG. 10 depicting an example compression and recoil sequence over time.

FIG. 13 is a schematic representation of the visual indicator of FIG. 10 depicting another example compression and recoil sequence over time

FIG. 14 is a schematic representation of the visual indicator of FIG. 10 depicting subsequent stages of the example compression and recoil sequence of FIG. 13.

FIG. 15 is a perspective view of example components of the manikin of FIG. 1.

FIG. 16 is a perspective view of an interior portion of the manikin FIG. 1.

FIG. 17 is another perspective view of the interior portion of the manikin of FIG. 1.

FIG. 18 is a perspective exploded view of components of the manikin of FIG. 1.

FIG. 19 is a perspective partially transparent view of a compression piston assembly of the manikin of FIG. 1.

FIG. 20 is a perspective view of a portion of the manikin of FIG. 1.

FIG. 21 is a schematic representation of a spring operationally connected to a chest compression plate and a bottom compression plate showing the relationship between spring length and inductance.

FIG. 22 is an example schematic diagram of a modified Colpitts oscillator and analog to digital converter.

FIG. 23 is a perspective exploded view of a head portion of a manikin of the present disclosure.

FIG. 24 is another perspective exploded view of the head portion shown in FIG. 23.

FIG. 25 is an exploded cross-sectional view of the head portion shown in FIG. 23.

FIG. 26 is a cross-sectional view of the head portion shown in FIG. 23.

FIG. 27 is a perspective partial cut away view of a portion the manikin head shown in FIG. 23.

FIG. 28 is a perspective view of a lung bag.

FIG. 29 is a perspective exploded view of a head portion with a lung bag attached.

FIG. 30 is a cross-sectional view of the head portion shown in FIG. 27.

FIG. 31 is a cross-sectional view of the head portion shown in FIG. 27.

FIG. 32 is a perspective view of a lung bag.

FIG. 33 is a perspective view of a portion of a manikin showing an airflow sensor.

FIG. 34 is a plan view of an adhesive element.

FIG. 35 is a sectional view of section 35-35 of FIG. 34.

FIG. 36 is a schematic cross-sectional view illustrating mounting of a lung bag.

FIG. 37 is a perspective exploded view of an airflow sensor.

FIG. 38 is a perspective partial view of an airflow sensor.

FIG. 39 is a schematic view of representative configuration of a portion of an airflow sensor.

FIG. 40 is a schematic view of representative electrical circuitry of a portion of an airflow sensor.

FIG. 41 is a cross-sectional view of internal components of a manikin.

FIG. 42 is a perspective view of an embodiment of a head and neck portion of a manikin.

FIG. 43 is a perspective exploded view of the head and neck portion of FIG. 42.

FIG. 44 is side, cross sectional view of the head and neck portion of FIG. 42.

FIG. 45 is a top plan view of an embodiment of an airway cup assembly of the head and neck portion of FIG. 42.

FIG. 46 is a side elevational view of the airway cup assembly of FIG. 45.

FIG. 47 is a top plan view of an upper portion of the airway cup assembly of FIG. 45.

FIG. 48 is a side elevational view of the upper portion of FIG. 47.

FIG. 49 is a top plan view of a lower portion of the airway cup assembly of FIG. 45.

FIG. 50 is a side elevational view of the lower portion of FIG. 49.

FIG. 51 is a top perspective view of a latch assembly of the head and neck portion of FIG. 42.

FIG. 52 is a perspective exploded view of the latch assembly of FIG. 51.

FIG. 53 is a perspective view of an embodiment of a lung bag.

### DETAILED DESCRIPTION

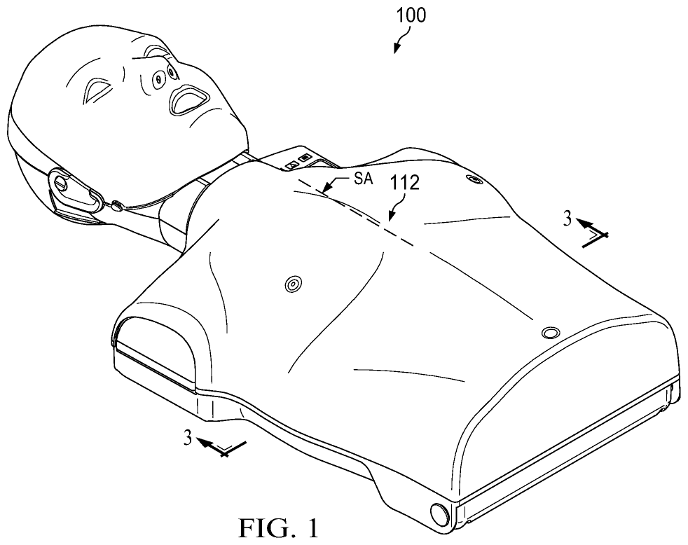

Certain embodiments are hereinafter described in detail in connection with the views and examples of FIGS. 1-41.

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Technical solutions to the problems associated with performing proper CPR can be achieved by the systems, apparatuses and methods of the present disclosure. The disclosed systems, apparatuses and methods achieve many and various improvements to manikins, including, but not limited to, intuitive visual and/or audible feedback, real-time skills performance feedback, skills testing both with and without feedback prompts activated, skills recording, and skills performance reporting. The benefits of these many and various features include cost effectiveness, ease of use by a lay person in, for example, CPR training, advanced CPR training for professionals, modular implementation of structures for various scenarios, ease of maintenance, and for future improvements, cleaning efficiency, intuitive set up/teardown, downloading of training session recordings and reports, programmable/reprogrammable components, and more, as disclosed herein.

In general, the systems, apparatuses and methods provide a simple and clear, relatively low cost solution to the problem of training students in proper CPR practices. Certain exemplary embodiments of the present disclosure are provided herein. In general, manikins can be used with or without feedback features. Feedback features can include both visual and audible prompts.

Referring now to FIG. 1, there is shown an exemplary embodiment of an apparatus, method and system for manikin users in proper hand placement during CPR chest compressions. A manikin 100 is provided. The manikin can have a size and shape of the upper torso area of a human, including a head and a chest area. The head and chest area can be operatively configured to generally mimic a human head, chest, respiratory and cardiopulmonary morphology. In general, the manikin 100 can comprise multiple external and internal components, and can have an outer surface that has the look, feel, and shape of the skin of a human. The manikin can include relevant visually distinguished anatomical landmarks, including the sternum, rib cage, sternal notch, and the xiphoid process. The manikin outer surface can be vinyl and latex free, being made of relatively durable, lightweight materials. The manikin can have removable outer surfaces, and in an embodiment can be in the form of a clamshell opening configuration (as shown below) for easy access to internal components. The manikin 100 can have an outer skin having portions thinned or otherwise made partially transparent or translucent such that visible signals, such as LED lighting (as described herein), can be visually detected through the skin. An example of a manikin that can be improved by the apparatuses, systems, and methods of the present disclosure is the PRESTAN ULTRALITE® Manikin available from MCR Medical Supply, Inc.

The manikin 100 has an optimal compression force location 112 which represents the optimal place to compress the chest portion of the manikin during chest compressions in CPR training. The optimal compression force location 112 is a portion of the chest that is situated over the location corresponding to the sternum of the ribcage of a person receiving CPR chest compressions. The optimal compression force location 112 can be located on an imaginary line corresponding to a sternum axis SA, that is, an imaginary axis oriented in line with the approximate center of the sternum. In general, for proper chest compressions, the hands of the person giving CPR chest compressions should be placed such that the sternum, rib cage and chest of the person receiving the CPR compresses uniformly downwardly (toward the surface upon which the person receiving the CPR is laying). Unbalanced forces could result in harm to an actual person receiving such unbalanced forces during compression.

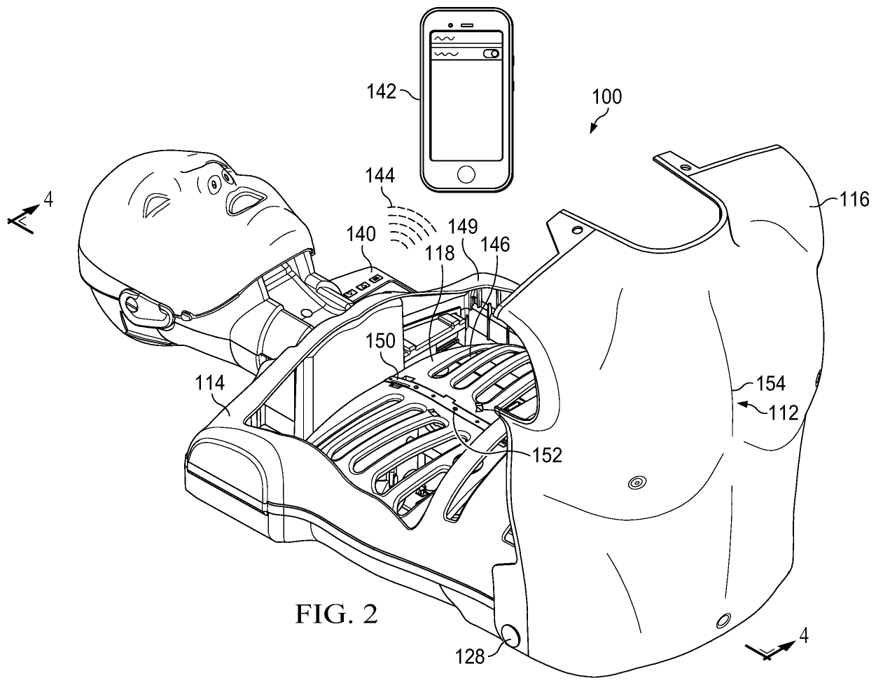

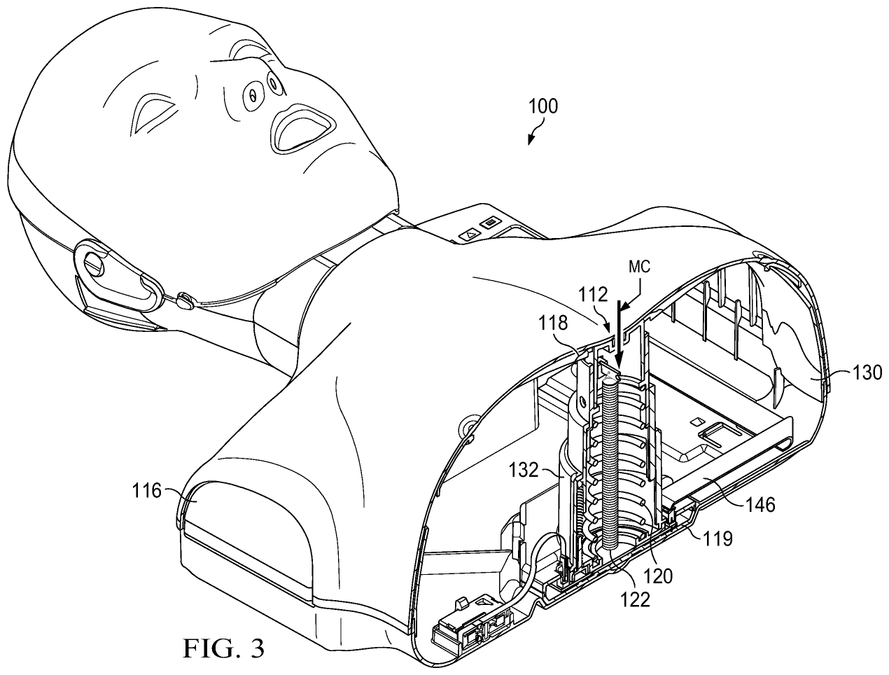

Referring now to FIG. 2, there is shown a clamshell opening manikin 100 that can be opened to show and allow access to internal components. In the illustrated embodiment, a lower torso surface 114 defines an internal cavity in which are placed in operational configuration various components, including a chest compression plate 118 and one or more springs, including a main compression spring 120 and at least one measuring spring 122, described in more detail below in connection with FIG. 3. In FIG. 2 the chest compression plate 118 is illustrated in the compressed position as it would be in use during a chest compression. An upper torso surface 116 is removably connected to the lower torso surface 114. In an embodiment, the upper torso surface 116 is pivotally joined to the lower torso surface 114 by pivot connection 127 about which the upper torso surface 116 can pivot relative to the lower torso surface 114.

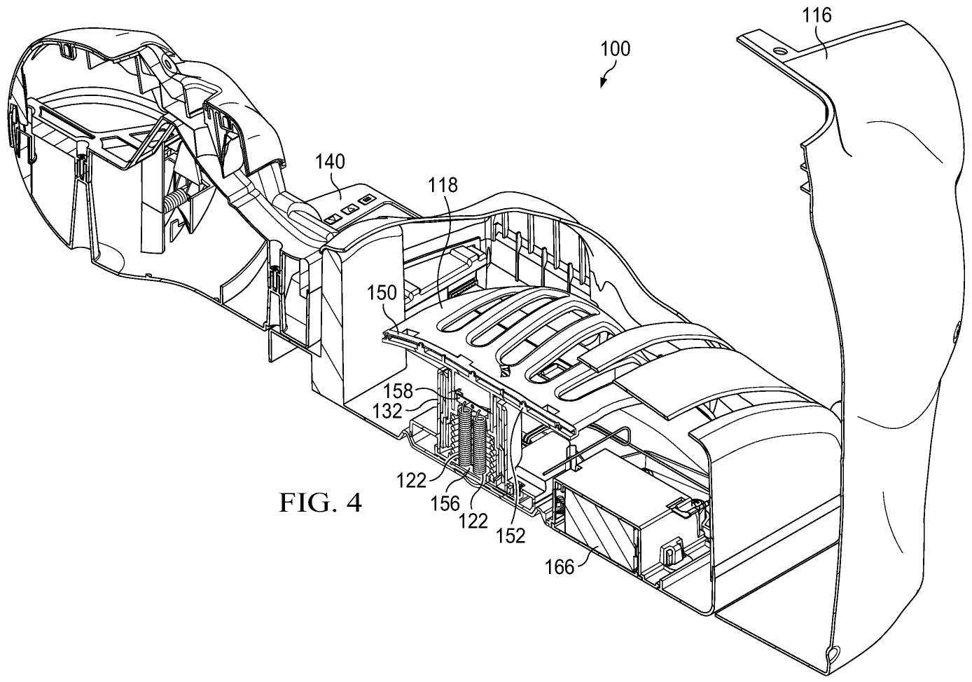

The chest compression plate 118 can be generally a size and shape to approximate a human rib cage. In a central portion of the chest compression plate 118 in an area corresponding to the sternum and being disposed generally linearly aligned to the sternum axis SA (when the upper torso surface 116 is closed) is a sternum printed circuit board assembly (sternum PCBA) 150 on which are operatively joined in electrically-powered communication with a power source a plurality of sternum LED lights 152 and/or switches for indicating proper hand placement during compression. The sternum LED lights 152 and/or switches can be generally evenly linearly disposed about a location corresponding to the optimal compression force location 112 and generally in line with the sternum axis SA, such that upon correct hand placement during compression a predetermined number, e.g., an equal number, of LED lights are visible on each side of the hands performing compression, or in combination or alternatively, an equal number of switches are activated and the result displayed for reading on, for example, a control device 140. All or a portion of the upper torso surface 116 can be sufficiently translucent such that light emitted from the sternum LED lights 152 can be visible during hand placement and compressions. In an embodiment a thinned portion 154 of the upper torso surface 116 generally proximate the area corresponding to the sternum can permit light emitted from the sternum LED lights 152 to be visible to users, trainers, and other associated with the use of the manikin 100. In an embodiment, upon placing the hands on the chest and/or during chest compression, the sternum LED lights 152 can be powered on to be visible through the upper torso surface 116, and visible to the user, a trainer, or others. In an embodiment, when the hands are placed in the proper location, i.e., on the optimal compression force location 112, an equal number of sternum LED lights 152 are visible on each side of the hands. In an embodiment, a user or trainer can utilize the sternum LED lights 152 alone or in combination with a visual display of results shown an electronic device, such as the control device 140, discussed below. All electrically-powered components, including the sternum LED lights and the control device 140, can be powered by a battery 166, as depicted in FIG. 4. Additionally or alternatively, the manikin 100, or any of the electrically-powered components, can be powered via a mains electric source.

Further illustrated in FIG. 2 is a control device 140 that can receive, record, analyze, transmit and/or display data including, for example, training feedback. The control device 140 can be an electronic device partially or fully embedded into the manikin 100, as shown in FIG. 2. The control device 140 can be directly connected via electrical wiring 146 to the manikin 100, that is, “plugged into” the manikin 100, and disposed in a receiving port 149, such as a slot, in the manikin 100. Removal of the control device 140 can be affected manually, that is, by grasping and pulling it. Likewise, installation of the control device 140 can be affected manually, that is, by pushing in until the electrical connections are properly seated. Alternatively, removal of the control device 140 can be via an actuator, such as a push-button activated ejector, as is known for the ejection of cassettes in electronic equipment. In some embodiments, the control device 140 can be indirectly connected to a remote device 142, which can be, for example, a smartphone, as shown in FIG. 2. In such embodiments, the control device 140 can be communicatively coupled to the remote device 142 via a wireless communications 144, such as Bluetooth® communication, Wi-Fi®, or any other suitable wireless communication technologies. Additionally, in an embodiment, the remote device 142 can also be configured to function as the control device 140. In such embodiment, the remote control device 140 communicates wirelessly with associated electronic transmissions components of the manikin 100.

The control device 140 can be a programmable device that can be programmed for scenarios such as, for example, training scenarios, as well as for recording and displaying feedback to a person being trained. The control device 140 can have memory and a processor that can be programmed with executable instructions to perform any number of predetermined scenarios such as, for example, predetermined training scenarios and/or feedback data, for example, via various control selectable features. The control device 140 can have a display screen, which can be an LCD display screen, on which can be a display that can show live or real-time graphical or text feedback, show compiled post performance, and/or make recommendations to the trainee. The LCD screen can also have selectable features that can be the control selectable features. In some embodiments, the control selectable features can be used to navigate various menus and line items that can be used to configure the manikin 100 for certain data analysis related to selected scenarios. In an embodiment, the manikin 100 can, e.g., via the control device 140, compile reports. In an embodiment, the data gathered, analyzed, transmitted and/or recorded by the control device 140 can be placed onto external memory devices, such as USB flash drives and/or computer servers and devices. In an embodiment, the control device 140 can have a USB port for data transmission to and/or from the control device 140 and an internal CPU, such as a CPU processor operatively joined to the lower PCBA. In an embodiment, the manikin 100 can have a USB port for data transmission to and/or from the manikin, including internal manikin components and/or the control device 140. The USB port(s) can be used with USB flash drives or other devices, such as a Bluetooth® dongle. The USB port(s) can be utilized to achieve software installation and updates. Wireless communication devices, such as a Bluetooth® dongle can be configured for wireless communication with remote devices such as computers and smartphones.

In some embodiments, a method can be performed using a manikin 100 including the control device 140, as follows. A CPR instructor, technician, or other person, can program a training scenario in the control device 140 by making selections on the display screen. A training scenario can include, or be related to, various criteria associated with CPR training, such as CPR chest compression rate and/or depth training; chest release/recoil timing; number of compressions; timing of compressions, accuracy of recoil; total training session time; ventilation volume; ventilation time; number of ventilations, accuracy of ventilations; hands off time; scoring for all the various measurements. During training, or after a training session is completed, or deemed completed, the trainee and/or instructor can receive feedback in the form of visual feedback on the control device 140 or visual feedback on a remote device in communication with the control device 140 or other components of the manikin. The feedback can also be audible, such as in the form of clicks or tones having meaning to the training session. The method can also include a scoring step in which the desired training criteria is reported with an analysis of the relative scoring criteria. Thus, the methods of the present disclosure can facilitate programmable training sessions that can be easily selected, performed, and reported. The methods can also facilitate real-time and/or delayed feedback on certain predetermined or selectable training criteria. The feedback can include visual or audible feedback via, for example, the control device 140, or a displayed and/or printed report of the training session, including optional scoring of the trainee's CPR session.

FIG. 3 is a view of cross-section 3-3 of FIG. 1 and shows certain internal components of the manikin 100 when the upper torso surface 116 is in a closed position and operable for use in activities such as, for example, training. Thus, the upper torso surface 116 is closed and operatively joined with the lower torso surface 114 defining an enclosed cavity 130 in which various components of the manikin 100 are disposed. In FIG. 3 the chest compression plate 118 is illustrated in the uncompressed position as it would be prior to a chest compression.

As depicted in FIG. 3, the manikin 100 can have a bottom compression plate 119 disposed on the lower torso surface 114 opposite the chest compression plate 118. The main compression spring 120 can be a spring operatively situated to resist compression between the chest compression plate 118 and the bottom compression plate 119 in vertical alignment with the direction of main compression MC and aligned with the location associated with the optimal compression force location 112. In an embodiment, the main compression spring 120 is a coil spring having a coil spring axis being longitudinally centered in the coil of the main compression spring 120, and thereby being oriented generally orthogonal to the sternum axis SA. In an embodiment, the coil spring axis intersects the sternum axis SA and is aligned with the direction of main compression MC. In an embodiment, the main compression spring 120 is a steel coil spring disposed in a telescoping piston sleeve 132 that encloses and protects the main compression spring 120.

Continuing to refer to FIG. 3, when the chest of the manikin 100 is compressed at the optimal compression force location 112, the main compression spring 120 is compressed and the chest compression plate 118 is translated toward the bottom compression plate 119 in the direction of main compression MC. The manikin 100 can include feedback mechanisms, including an audible click, when the chest compression plate 118 is compressed a sufficient and correct distance.

FIG. 4 is a view of cross-section 4-4 of FIG. 2 and shows certain internal components of the manikin 100, including the chest compression plate 118 in a compressed state. As depicted, the upper torso surface 116 is in an open position relative to the lower torso surface 114, thus rendering open what was the enclosed cavity 130 in which various components of the manikin 100 are operationally disposed. The cross-sectional view of FIG. 4 provides for a better view of an example orientation and the number of measuring springs 122. In the illustrated embodiment two measuring springs 122 are disposed internally to the main compression spring 120. Each of the measuring springs 122 are connected at a lower end to a lower spring PCBA 156 (which can be in electrical communication with the control device 140 via electrical wiring 146) and at an upper end to a connector PCBA 158. The measuring springs 122 are metal or electrically conductive, and are electrically connected in series to complete a circuit from lower spring PCBA 156 and through the connector PCBA 158. As discussed more fully below, the inductance characteristics of the measuring springs 122 can be detected and analyzed to determine length changes of the measuring springs 122, which length changes are used to calculate depth of compression of the main compression spring 120 during compression of the chest compression plate 118 in the direction of main compression MC, as shown in FIG. 3. The measuring springs 122 are each joined at a first end by electrical connection to the lower spring PCBA 156 and at a second end to the connector PCBA 158 to make a complete electrical circuit that is in electrical communication with analysis components and the electrical wiring 146 to provide for measuring spring compression data to the control device 140. The two measuring springs 122 are each secured in an electrical connection, such as soldered, that permits a complete electrical circuit through both measuring springs 122 in, for example, a series connection.

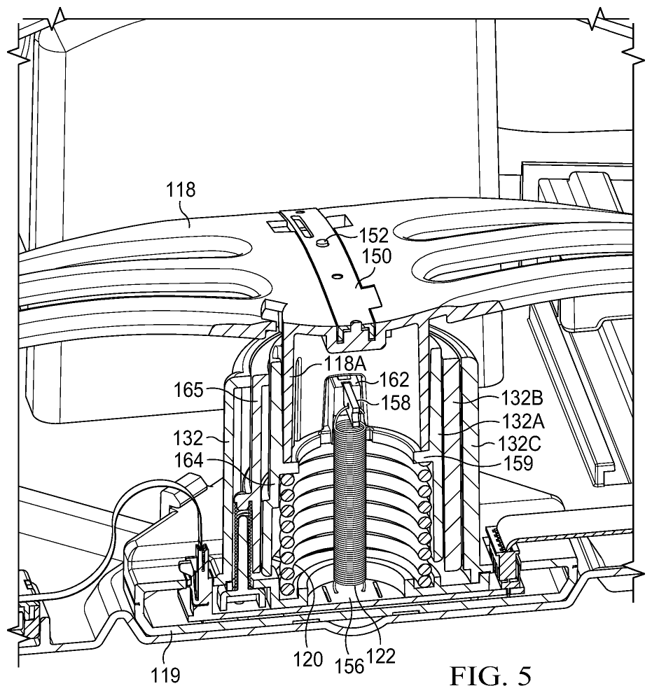

Referring now to FIG. 5, various features of the manikin 100 are shown in greater detail. The chest compression plate 118 can have a plate extension 118A that extends generally orthogonally from a bottom surface of the chest compression plate 118 from a generally centrally located portion of the chest compression plate 118 and extends toward and is secured to a portion of the telescoping piston sleeve 132. In the illustrated embodiment, the plate extension 118A is generally cylindrically shaped and sized to fit into a generally cylindrically shaped portion of the telescoping piston sleeve 132. In the illustrated embodiment, the telescoping piston sleeve 132 comprises three portions, a first upper portion 132A, a second middle portion 132B, and a third lower portion 132C. The first upper portion 132A is generally cylindrical and can have an inwardly protruding annular extension 159 that acts as a physical barrier upon which the plate extension 118A can rest on one side, and which acts on the other side to compress the main compression spring 120 when the chest compression plate 118 is pressed downwardly. Thus, in an embodiment the outer diameter of the main compression spring 120 can be approximately the same as, or slightly less than, the inner diameter of the first upper portion 132A. The first upper portion 132A can also have a portion fitted to secure the connector PCBA 158 upon which the measuring springs 122 are connected. Thus, the magnitude of the change in length of the measuring springs 122 is directly proportional to, and matches, the magnitude of the change in length of the main compression spring 120. The second middle portion 132B provides for moveable protection of the main compression spring 120 and measuring springs 122 during compression and extension of the main compression spring 120. The third lower portion 132C can also serve as the telescoping sleeve outer housing and includes a base which can be, or include, the bottom compression plate 119. In general, the telescoping portions can be molded, including injection molded, polymeric or composite material, and can have any features, including molded features, such as internally disposed annular ledge 164 and internally disposed annular extension 165 that permit telescoping movement in cooperation as the telescoping piston sleeve 132, but limit movement beyond desired extremes.

As discussed above, one or a plurality of springs, such as the measuring springs 122, can be electrically conductive in an inductive circuit to detect, measure, record, and/or report dimensional changes related to the chest compression plate 118. Thus, as can be understood from the description above, an embodiment of a manikin 100 apparatus can have one or more measuring springs 122 that operate in conjunction with a main compression spring 120 and the control device 140 to monitor, measure, detect, and/or display chest compression data and provide feedback to a person doing chest compressions on the manikin 100. In an embodiment, the data include depth of compression measures. In general, therefore, the system includes a manikin, a central compression spring separating a chest compression plate and a bottom compression plate, and one or more measuring springs that are operationally configured to detect tilt of the chest compression plate during chest compression. The operational configuration can include electrical or electronic connections, and all wiring, connections, printed circuit boards, and the like. In general, the springs, including the measuring springs 122 are configured as an air core inductor, whose inductance value is governed by its physical mechanical properties according to known mathematical relationships. By converting the inductance of the coil springs to a frequency, and then converting the frequency to a distance dimension, the distance dimension, e.g., length (and changes in length) of the coil springs, can be accurately determined, recorded, and/or reported. The dimensional changes can be correlated to movement of the chest compression plate, and the depth of compression can be quantified and reported.

Depth measure of chest compressions can also be detected and reported by switches and sensors, as discussed below, as well as the inductive coils described above, or other methods for detecting changes in dimensions. Prior to compression the chest compression plate 118 is a maximum distance from, and can be generally parallel to, the bottom compression plate 119. The terms “parallel to” and “maximum distance from” are used in a general sense, and not in an absolute sense. That is, for example, the “maximum distance” is intended to be the starting, pre-compression distance between a lowermost portion of the chest compression plate 118 and an uppermost portion of the bottom compression plate 119. And “parallel to” recognizes that one or both of the chest compression plate 118 and the bottom compression plate 119 can have various geometrical shapes, extensions, protrusions, and the like, but their overall configuration can approximate parallel plates.

A representative method of using the apparatus according to the system disclosed herein, can include a user positioning their hands on the chest portion of the manikin 100 in what is believed to be a correct position. After compressing the chest of the manikin 100, i.e., pressing the chest compression plate 118 toward the bottom compression plate 119, the user receives feedback, including visual, audible, or both, as to the correct positioning of their hands based on the position of the chest compression plate 118, including in an embodiment, whether the depth of the chest compression plate 118 meets or exceeds pre-set thresholds. Upon notification that such thresholds are met or exceeded, and feedback is provided, the user can reposition and try again. This method can be repeated as desired. In another embodiment, the feedback can be in the form of the sternum LEDs 152 indicating correct hand placement by, for example, having an equal number of LEDs 152 activated and visible on each side of the user's hands.

Note that the system components described are described for operation of the method, but certain components can be combined without departing from the scope of the disclosure. For example, the bottom compression plate 119 can be integral with, and indistinguishable from, a portion of the lower torso surface 114 that functionally serves as the bottom compression plate.

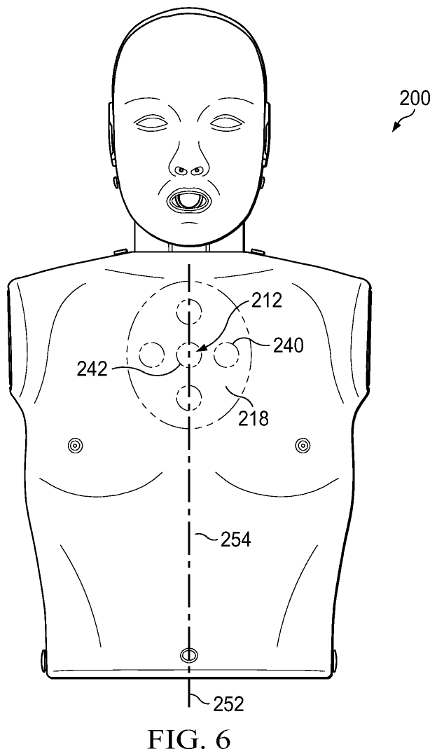

Referring now to FIG. 6, there is shown a representative embodiment of a manikin 200 apparatus that in conjunction with representative systems and methods as disclosed herein, can provide proper hand positioning feedback to a person training in CPR chest compressions. The manikin 200 can have any and all of the features described above with respect to the manikin 100. As shown in FIG. 6, the manikin 200 can have a chest compression plate 218 operationally positioned such that a central portion thereof aligns with an optimal compression force location 212. In the illustrated embodiment, the chest compression plate 218 is generally circular or oval-shaped. As indicated in FIG. 6, the chest compression plate 218 lies under an outer surface of the manikin 200, but in an embodiment it can lie external to the manikin external surface.

When the chest compression plate 218 is compressed with proper hand positioning by the person doing chest compressions, for example against the force of a main compression spring as described above, the chest compression plate 218 compresses without tilting. However, if the user's hands are not placed in a correct position, the compression pressure tends to be offset from the center corresponding to the optimal compression force location 212, and the chest compression plate 218 will tilt more in the direction of the offset hand position placement.

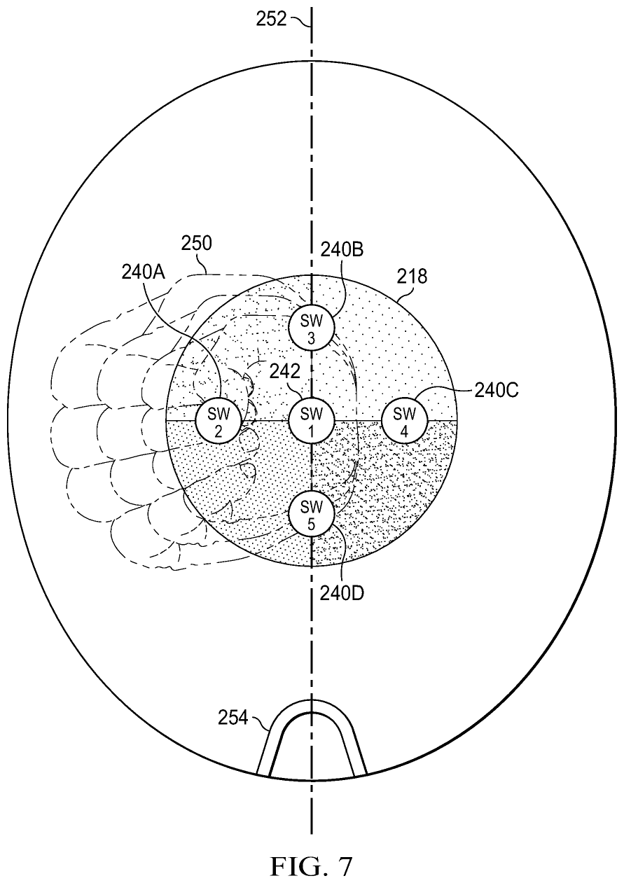

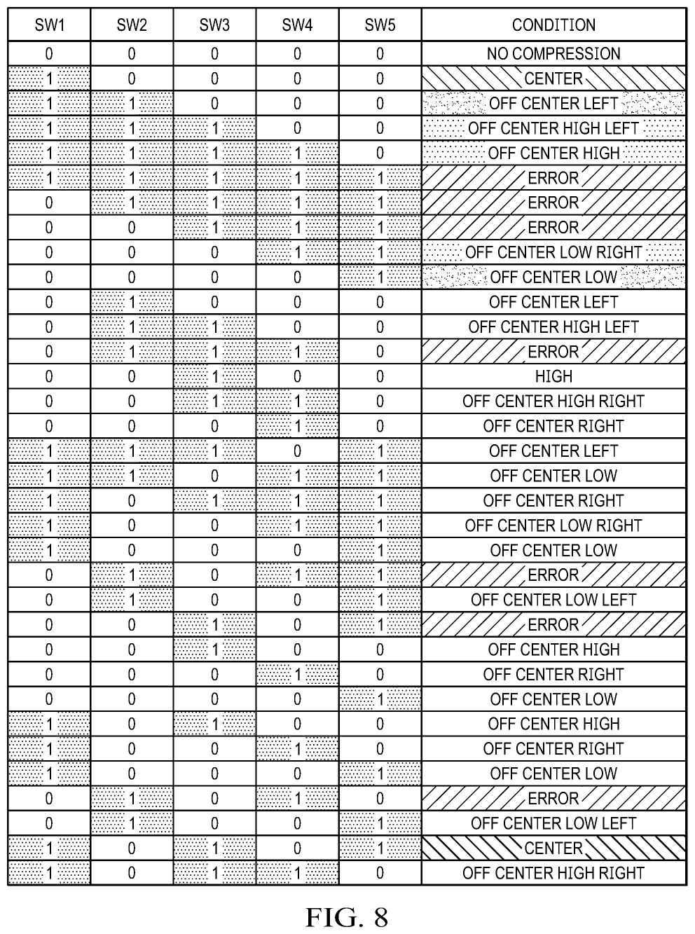

Referring to FIG. 7, the chest compression plate 218 has associated therewith a plurality of offset switches 240 that can be arranged a distance from a central switch 242 that lies substantially aligned vertically at the optimal compression force location 212. In the embodiment shown, five switches are shown, and they can be considered for the purposes of understanding the chart shown in FIG. 8 as switch one 242 centrally located to correspond to the optimal compression force location 212 on manikin 200. The remaining four switches are disposed about switch one 242 and can be, for descriptive purposes termed peripheral switches, and can be identified as switch two 240A, switch three 240B, switch four 240C, and switch five 240D. Further, for descriptive purposes for understanding the general concept, the switches can be positioned with respect to an imaginary sternum centerline 252 and other anatomical features, such as the xiphoid process 254.

The switches 240, 242 on manikin 200 can be electrical switches. The switches 240, 242 can be small membrane or tact switches, for example. Each switch 240, 242 can be normally open, such that if pressed above a certain pressure threshold the switch closes. A closed (or otherwise activated) switch can indicate correct hand pressure, as when only switch one 242 closes upon pressure by a user's hands 250 training in chest compressions on the manikin 200. An open peripheral switch closing, on the other hand, can indicate improper hand placement during chest compressions. The chart of FIG. 8 is representative of one embodiment of the feedback that can be supplied to a user during chest compressions of the manikin 200 having the switch configuration of FIG. 7. Of course, it is understood that other switch configurations, numbers, placements, and the like can be utilized without departing from the scope of this disclosure.

As discussed above, tilt of the chest compression plate, switches, and/or dimensional changes in the length of components such as coil springs can be measured, recorded, and reported. Additionally, as discussed above, detecting these dimensional changes can be useful in training against uneven pressing of the chest plate of a CPR manikin. Further, as discussed above, this dimensional change can be determined by taking advantage of the electrical properties of a conductive coil spring in an electrical circuit, particularly the property of inductance. Such properties and how they are leveraged in the current apparatus for systems and methods of CPR training are disclosed. For example, the difference between the respective length changes of two springs in a system, as discussed above, can be utilized to determine an uneven, i.e., a tilted, condition during compression of a chest plate in a CPR manikin. Likewise, as more fully described below, such length changes can be utilized to determine a distance dimension change related to depth measurement during compression of a chest plate in a CPR manikin.

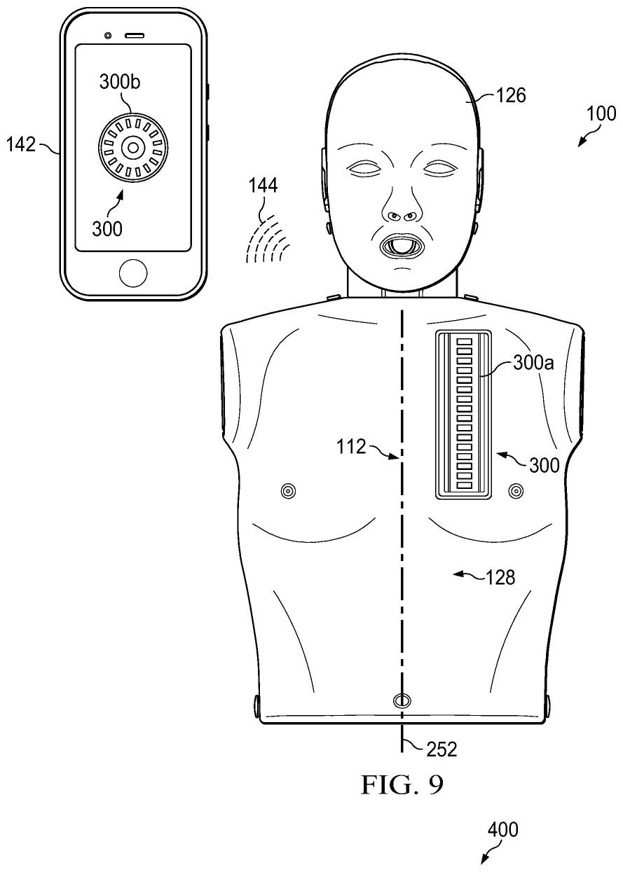

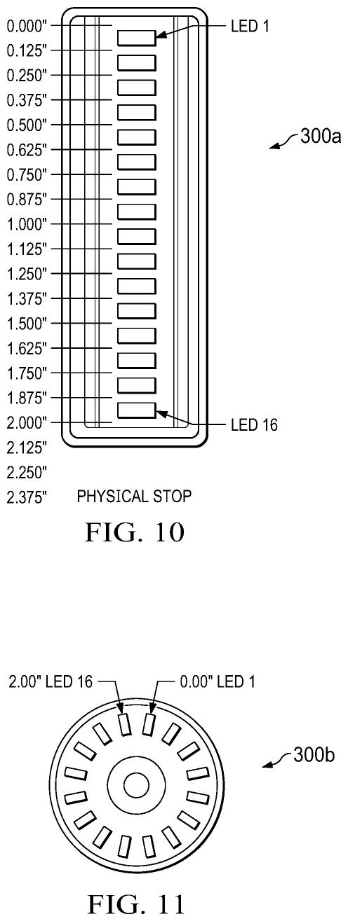

In an embodiment, the manikin 100, or the manikin 200, can have components and features to provide feedback, including real time feedback, for depth of compression, rate of compression, recoil, and, in embodiments, breathing parameters. The manikin 100, 200 can have associated therewith, either on or in the manikin, or remote from the manikin, a visual display 300, as depicted in FIG. 9. The visual display 300 can take various configurations, including a display 300a having a series of linearly oriented LEDs integrated into the chest area 128 of the manikin 100, 200, as depicted in FIG. 9, and in more detail in FIG. 10 which shows additional information related to chest compression depth measurements. Other configurations, such as display 300b, can include a generally circularly configured LEDs as shown in FIG. 11. Regardless of configuration, a series of LEDs, each representing an incremental depth dimension, such as ⅛th inch, can be individually activated as the chest of the manikin 100, 200 is compressed to the indicated depth. Depth measure can be by switches, sensors, the inductive coils described above, or other methods for detecting changes in dimensions. The number and incremental depth indication can be preconfigured. The “bar graph” of LEDs on the visual display 300 can provide graphical data to a user to provide real time feedback on chest compressions. The visual display 300 (e.g., the visual display 300a, the visual display 300b, etc.) can be mounted on or in the manikin 100, 200, or it can be on a remote device 142, such as a computer or smartphone, and can be activated wirelessly by wireless communications 144, as depicted in FIG. 9.

In an embodiment each LED of the visual display 300 can sequentially activate with each ⅛th inch depth increase (e.g., a ⅛th inch main compression spring length decrease). With ⅛th inch increments a total of 16 LEDs is sufficient, as depth compression of two inches is currently considered a proper depth of compression, and within the recommended range of between 2 inches and 2.4 inches. However, in embodiments, the visual display 300 can also indicate over-travel of between about 2 inches and about 2.5 inches. It should be appreciated that the functionality of the visual display 300 and any preconfigured measurement thresholds can be reconfigured in response to future changes in CPR administration and/or training protocols.

In an embodiment, one or more LEDs of the visual display 300 can be multi-color, with the color of an activated LED signaling a predetermined feedback parameter of the system. For example, when the visual display 300 is utilized for chest compressions, an activated LED can indicate the depth of compression, but the color of the LED can provide feedback with respect to the rate of chest compressions. For example, an activated LED indicating the depth can be red if the compressions per minute (CPM) are less than 100; green if the CPM is between 100 and 120; and red if the CPM exceeds 120.

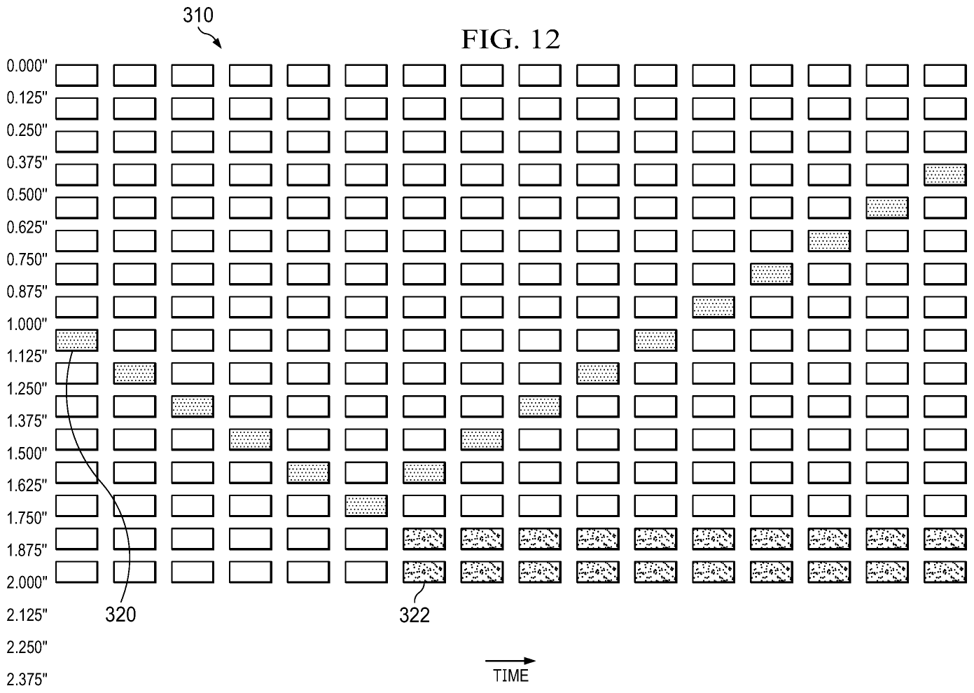

Referring now to FIG. 12, there is illustrated an example method of the apparatus and system disclosed. FIG. 12 depicts a sequence 310 of one chest compression and recoil as visualized on the visual display 300 as depicted in FIG. 10 over a span of time and depicts the depth as the chest is compressed and released, as well as feedback as to proper depth compression. Thus, the depiction in FIG. 12 is one example of feedback, but it is understood that other methods can be used for other feedback. As depicted, as a first instance in time (far left), the chest compression is shown to be a depth of 1.125 inches by an activated LED 320, which can be green in color. As the chest compression continues in time, the LED, which can be a green LED, sequentially shows greater depth, to a maximum depth compression of 1.750 inches at the sixth sequence, at which time chest pressure is released and chest recoil begins, and the LEDs activate in reverse sequence, in the illustrated embodiment to a depth of 0.500 inches. Also depicted in FIG. 12 is a feature that provides feedback to a person performing the chest compressions when a proper depth of two inches was not reached. Specifically, once the recoil begins, an error LED 322, which can be red, activates to indicate one or more incremental depth distances that the chest compression fell short.

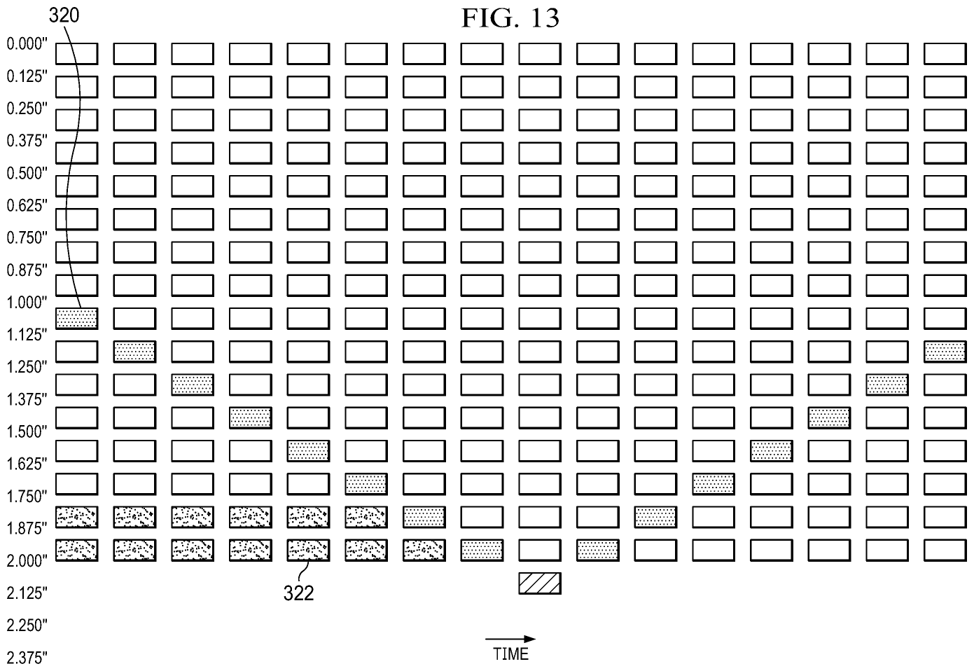

Thus, in the representative method disclosed, when a chest compression does not go deep enough, an error LED will activate in the form of a red LED, and can stay activated until a next chest compression that goes to at least the proper depth of 2 inches as depicted in FIG. 13. On the next chest compression, the chest is compressed to a depth of 2.00 inches (at the eighth sequence), at which time the red error LEDs 322 are de-activated, and continues to a maximum depth of 2.125 inches (at the ninth sequence) before chest pressure is released and chest recoil begins.

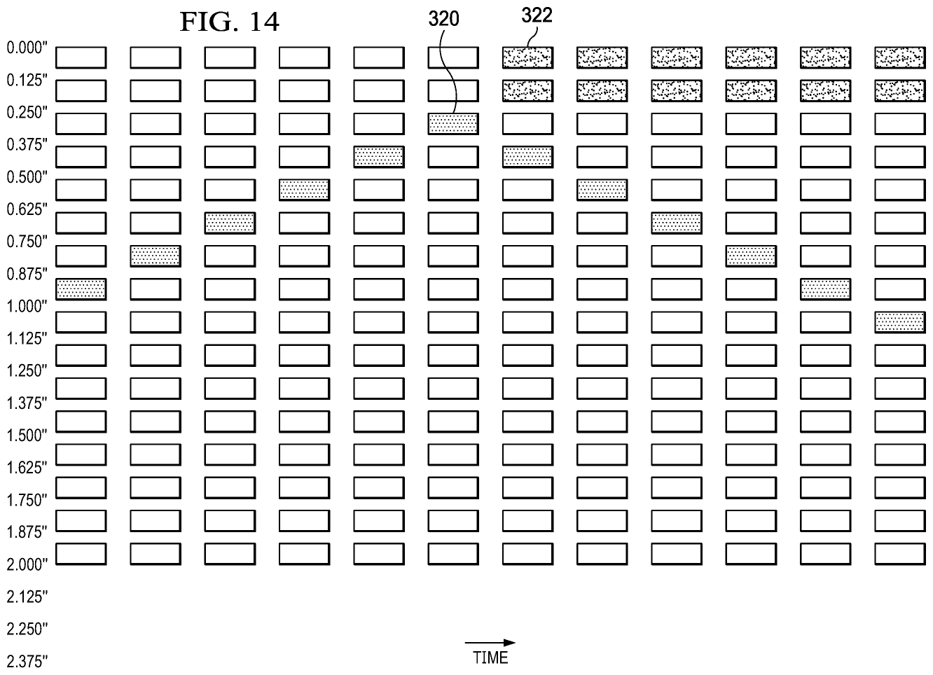

A further example of a method of the system can be illustrated with continuing reference to FIG. 13, as well as the depiction in FIG. 14. As can be understood in the diagram of FIG. 13, at the release of chest pressure, chest recoil occurs, but in the illustrated depiction, only to a chest depth of 1.250 inches. Subsequent chest recoil is shown in FIG. 14, which depicts an activated LED 320 at a maximum chest recoil of 0.375 inches (at the sixth sequence), which is short of the proper depth of zero inches (full chest recoil). In this example, subsequent chest compression that starts from a position of less than full recoil, an error LED 322 can be activated, and can remain activated until in subsequent chest compressions the chest recoil is permitted to return to, for example, 0.00 inches.

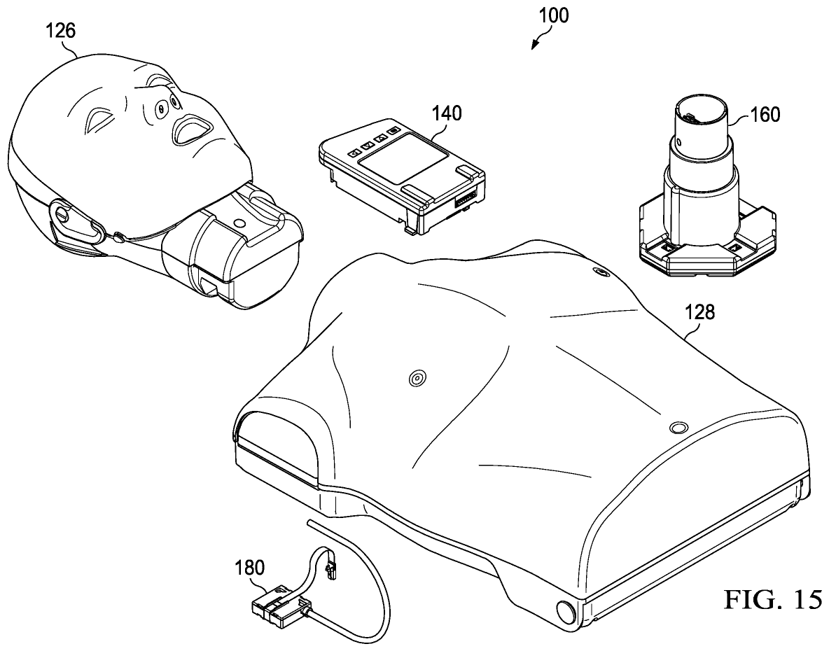

Additional features and benefits of a manikin 100, 200 of the present disclosure can be described with reference to additional components, including components in the head portion 126 and components that facilitate operational cooperation with the chest area 128 of the manikin 100, 200. As depicted in FIG. 15 certain components that can be assembled into a manikin 100, 200 include the head portion 126, which as described below has certain beneficial features and benefits, and which can be modularly attachable to a chest area 128. The chest area 128 can have operationally configured therein various components, including the aforementioned control device 140 that can have control buttons and a visual display, such as an LCD display. Further, the aforementioned main compression spring 120 can be a component in a compression piston assembly 160. A breath module assembly 180 including an airflow sensor can be implemented to provide feedback related to breaths delivered during CPR training. Each of these components are described in more detail below.

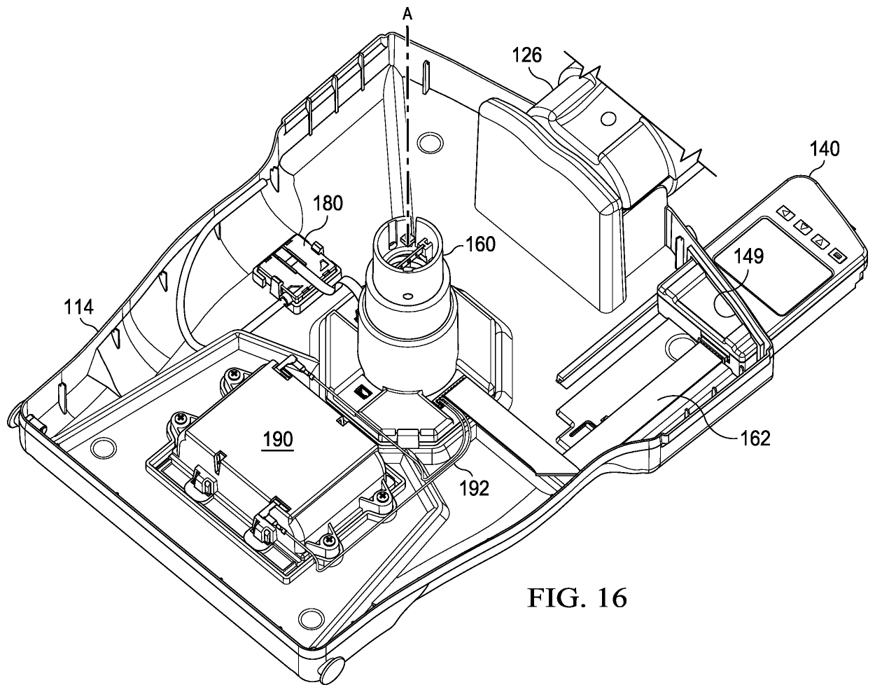

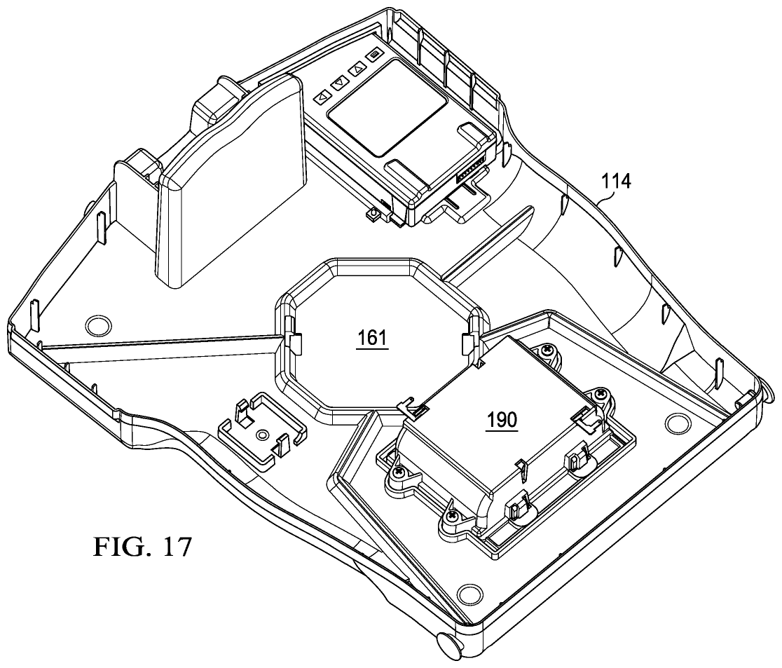

Referring now to FIG. 16 a portion of the lower torso surface 114 is shown with a representative configuration of various components. As shown, the control device 140 can be operatively inserted and removed from an interior position (as indicated in FIG. 17) via the receiving port 149. In an embodiment, the manikin 100, 200 can be operated with the control device 140 in the interior seated position (as indicated in FIG. 17) or in a fully external position, or a partially external position (as indicated in FIG. 16). In any wired configuration, the control device 140 can be wired via a wiring harness 162, which can be, or can include, electrical wiring 146 as disclosed above, to other electrical or electronic components, such as processors, memory, timers, and the like, which can have programmable capability and executable instructions for performing the various methodologies disclosed herein. Any or all of the electrical components can be powered by an external power supply, including line voltage, or by an internal power supply 190, which can be a battery connected to the electrical or electronic components via power supply wiring 192. A compression piston assembly 160 includes the telescoping piston sleeve 132 and the main compression spring 120 as disclosed above, and can be positioned generally centrally, being in axial alignment with an imaginary axis A extending through the optimal compression force location 112 on manikin 100, 200 as discussed above. The manikin body parts, such as lower torso surface 114, can be molded plastic, and can have features molded in for strength, component positioning, and the like. For example, as depicted in FIG. 17, the central molded feature 161 in which the compression piston assembly 160 rests can have a shape that keys the correct positioning of the compression piston assembly 160 in place. As shown in FIG. 17, the central molded feature 161 has an octagonal shape, and the base of the compression piston assembly 160 can have the same shape, and can be sized to be seated in the central molded feature 161. It should be appreciated that the central molded feature 161 can have any other shape configured to cooperate with the shape of the base of the compression piston assembly 160.

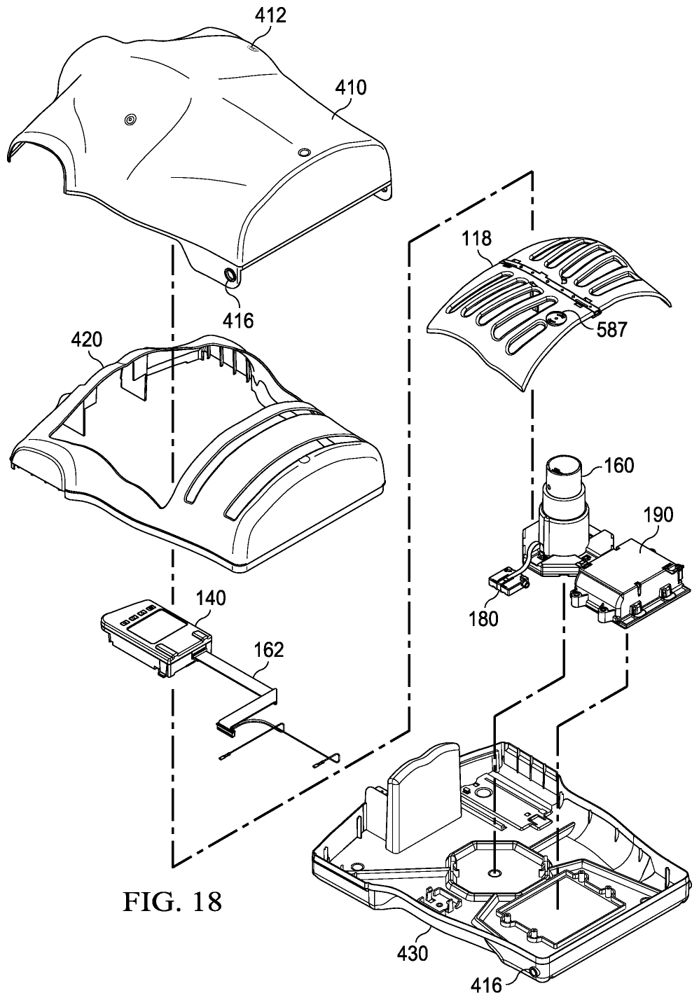

Referring now to FIG. 18 there is depicted an exploded view of an example embodiment of a torso assembly 400 for the chest area 128 for a manikin 100. The torso assembly 400 includes internal and external components, and when assembled provides for a lifelike human torso having CPR training and feedback capabilities. As shown, the torso assembly 400 can be a clamshell style assembly, but it need not be; in an embodiment any or all of the depicted portions can be stacked and assembled. The torso assembly 400 can include any or all of the features described above, including the control device 140, the wiring harness 162, the compression piston assembly 160, an internal power supply 190, and the breath module assembly 180.

The torso assembly 400 can have a torso skin 410, which is the outermost layer and can be the layer contacted by a person training in CPR. The torso skin 410 can be an elastomeric material having tactile properties to mimic human skin. The torso skin 410 can be a molded, pliable material that is realistic to the eye and touch; resists dirt, grime, and grease; is durable and easy to clean; and allows AED pads to adhere to the manikin without leaving adhesive residue behind, as is used on PRESTAN® manikins. The torso skin 410 can have molded features 412, such as a collarbone, nipples and/or a nipple line, an obvious xiphoid process, rib-cage lines, and a breastbone structure. The torso skin 410 can be latex-free and can be Restriction of Hazardous Substances (RoHS) and/or Registration, Evaluation, Authorization, and Restriction of Chemicals (REACH) compliant.

The torso assembly 400 can have a torso base 430, which can be the lower torso surface 114, or a part of the lower torso surface 114, described above. In the embodiment illustrated in FIG. 18, torso hinge pins (not shown) can engage the aligned torso hinge connector openings 416 on the torso base 430 and the torso skin 410, or other parts, to achieve the clamshell opening style manikin 100. A torso support 420 having a generally conforming shape to the torso skin 410 can provide flexible stiffness to the torso skin 410 such that when the torso skin 410 is layered on the torso support 420, the combination renders the chest portion of the manikin to have a flexible stiffness mimicking a human chest. The torso support 420 can have an opening defined therein in which can be disposed the chest compression plate 118, as described herein.

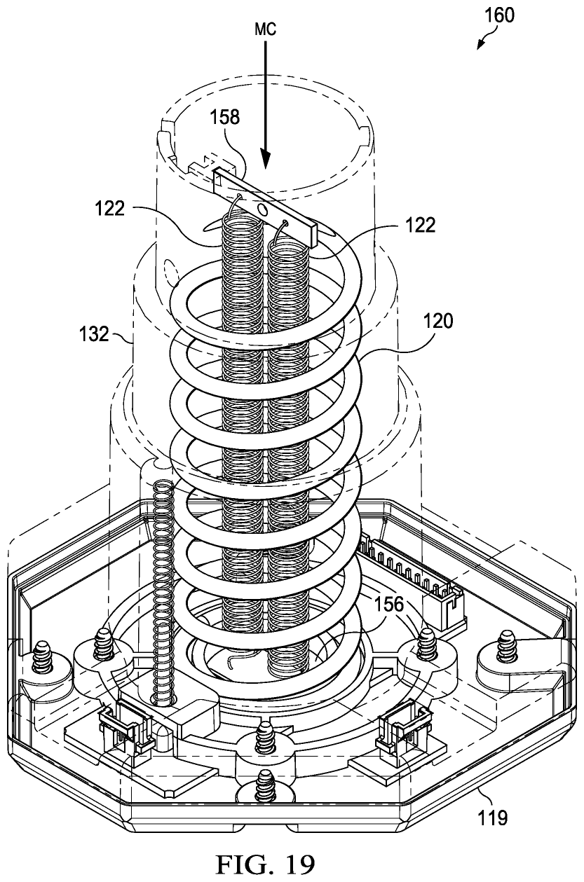

FIG. 19 shows certain components of a representative example of the compression piston assembly 160. The compression piston assembly 160 can be disposed between the chest compression plate 118 and the torso base 430 (or a bottom compression plate 119 as described above) and constrains the main compression spring 120 in vertical alignment with the direction of main compression MC at the optimal compression force location 112, as discussed above. The main compression spring 120 can be disposed in a telescoping piston sleeve 132 that encloses and protects the main compression spring 120 while permitting compression and extension of the main compression spring 120. In an embodiment of a manikin for measuring depth compression during chest compressions, the system can include audio and/or visual feedback to indicate a compression of the main compression spring 120 of between about 1 inches and about 3 inches, or between about 1.5 inches and about 2.5 inches, or between about 2 inches (5 cm) and about 2.5 inches (6 cm). One or more measuring springs 122 are disposed internally to the main compression spring 120. Each of the measuring springs 122 are connected in electrical communication at a lower end to a lower spring PCBA 156 and at an upper end to a connector PCBA 158.

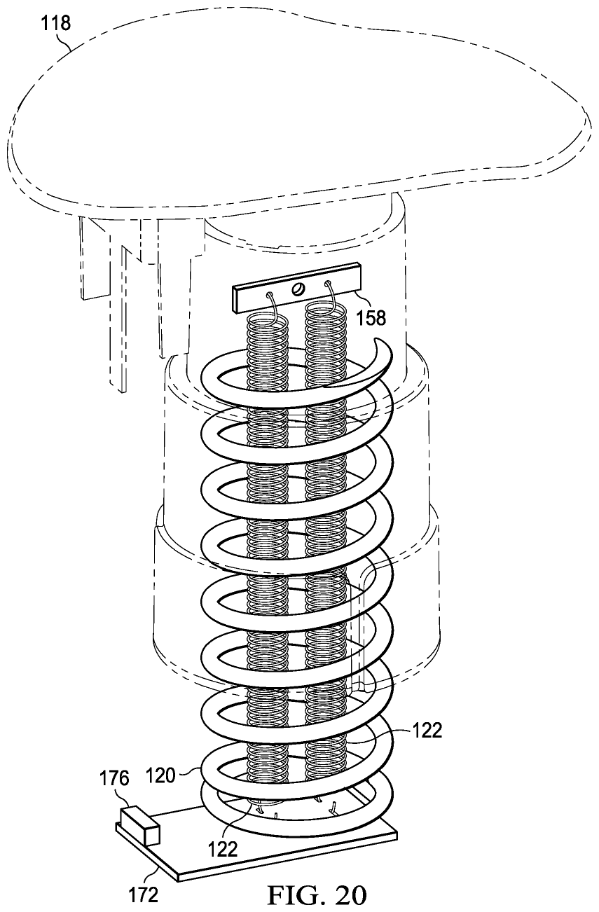

As shown in FIGS. 19 and 20, the measuring springs 122 can be depth measure springs disposed near the coil of the main compression spring 120 and extending generally parallel to the main compression spring 120. In an embodiment, fewer, i.e., 1, or more depth measure springs can be utilized. The measuring springs 122 are constrained by electrical connection at their respective ends, and compress and relax with a corresponding compression and relaxation of the main compression spring 120. One end of each main compression spring 120 can be joined, directly or indirectly, to the chest compression plate 118, and the other end of each measuring spring 122 can be connected, directly or indirectly, to a lower spring PCBA 156. The connection to the PCBA can include an electrical connection for energizing the measuring springs 122. The dimensional change of the length of the measuring springs 122 during chest compression can be determined by an LC oscillator circuit, described below, and reported as a measure of the depth compression of the chest of the manikin. The measuring springs 122 can be located relatively near the main compression spring, including in the interior thereof as depicted in FIGS. 19 and 20, and thus, near the imaginary central axis that is an axis co-axial with the central axis of the main compression spring 120. In an embodiment, one or more measuring springs 122 can be disposed between 0.0 inches and about 3 inches from the central axis of the main compression spring 120. The dimensional shortening of the measuring springs 122 can be detected, measured, recorded, and/or reported as a depth of compression of the main compression spring 120 during chest compressions on a manikin, such as the manikin 100 or the manikin 200. Representative visual feedback can be in the form of an image presented to the user showing the depth of chest compressions, including under or over compression and visual indications for correction. The visual image can be received via wireless communication to a user's smartphone, or other device, or to a dedicated device component of the manikin such as an LCD panel and/or a plurality of LEDs designed into the manikin 100, 200, as described herein. In addition to depth compression detected as length dimension changes, the LC oscillator circuit described herein additionally allows the detection of absolute depth compression of the chest compression plate 118 at varying points in time, whether the chest compression plate 118 is in motion or not, and static position. Thus, in a training scenario, depth of compression, rate of compression, recoil, and “hands off” time can be determined, recorded, and/or reported. Communications between the PCBA and other components of the manikin can be achieved wirelessly via, for example, Bluetooth® transmission, or wired via a connector 176.

As discussed above, dimensional changes in the length of components such as coil springs can be measured, recorded, and reported. Additionally, as discussed above, detecting these dimensional changes can be useful in training against uneven pressing of the chest plate of a CPR manikin. Further, as discussed above, this dimensional change can be determined by taking advantage of the electrical properties of a conductive coil spring in an electrical circuit, particularly the property of inductance. Such properties and how they are leveraged in the current apparatus for systems and methods of CPR training are disclosed. For example, the difference between the respective length changes of two springs in a system, as discussed above, can be utilized to determine an uneven, i.e., a tilted, condition during compression of a chest plate in a CPR manikin. Likewise, as more fully described below, such length changes can be utilized to determine a distance dimension change related to depth measurement during compression of a chest plate in a CPR manikin.

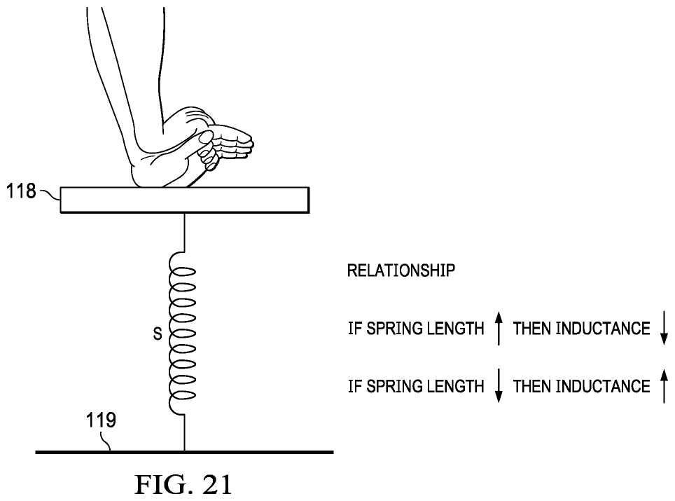

Referring now to FIG. 21, there is shown a schematic representation of a coil spring S operationally connected to a chest compression plate 118 and a bottom compression plate 119. In general, the coil spring S is an air core inductor, whose inductance value is governed by its physical mechanical properties. By converting the inductance of the coil spring S to a frequency, and then converting the frequency to a distance dimension, the distance dimension, e.g., length (and changes in length) of the coil spring S, can be accurately determined, recorded, and/or reported As indicated in FIG. 21, the basic relationship between spring S length and inductance is linear, with inductance being proportional to the length of the spring S coil. As shown, as spring length increases inductance decreases, and as spring S length decreases, inductance increases. Thus, in operation in the apparatus and system disclosed herein, a coil spring S, which can be a main compression spring 120 and/or one of the plurality of measuring springs 122, or other spring, can be utilized to measure dimensions and dimensional changes during chest compressions on a manikin. As the chest compression plate 118 is compressed during a training chest compression, any of the various springs associated with the chest compression plate 118 can change length, and thus inductance, and the inductance can be converted to a distance dimensional change.

The conversion of an inductance measure to a distance measure is accomplished by first converting inductance to a frequency measurement and then converting the frequency measurement into a linear dimension, e.g., length which correlates to distance. Inductance can be converted to a frequency waveform by utilization of a resonant circuit, such an inductor/capacitor (LC) oscillator circuit using a spring as an inductor component.

In an embodiment, the LC oscillator can use an NPN transistor to keep the resonant frequency of the circuit constant as a voltage powering the circuit varies. Thus, for example, for an apparatus powered by batteries, as the battery voltage drops, the resonant frequency can remain stable. A Colpitts oscillator tank circuit is an example of an LC oscillator comprised of an inductor and two capacitors forming a voltage divider. 2 The output of such an oscillator can be taken from the collector of the NPN transistor and is a sinusoidal signal. The sinusoidal signal can be converted to a digital square wave signal, such as be feeding it through an analog to digital converter, such as a Schmidt trigger to buffer and convert it.

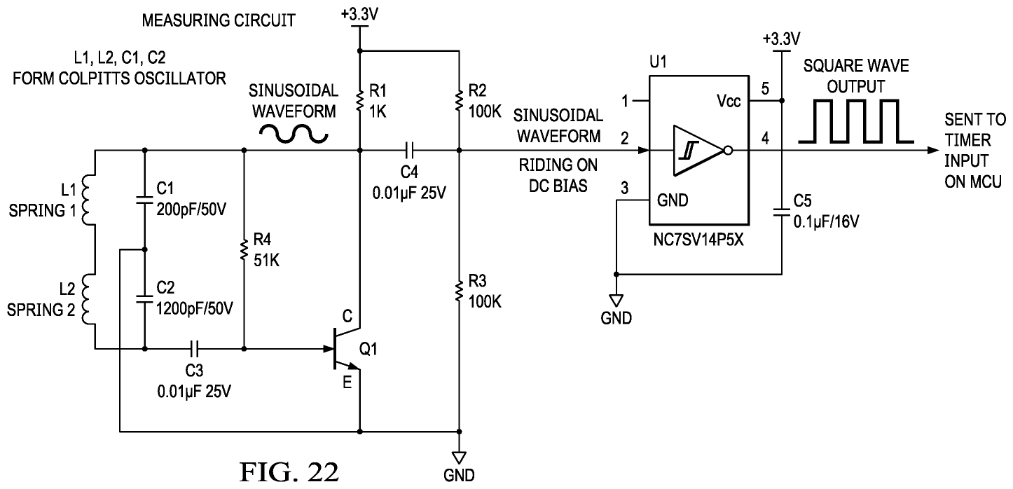

In the disclosed embodiments utilizing springs that change length during operation, the LC oscillator can be a modified Colpitts circuit, such that the inductors are not fixed, but can be variable. An example LC oscillator circuit in which a fixed inductor is replaced by a variable inductor in the LC circuit is shown in FIG. 22, which includes two variable inductors indicated as Spring 1 and Spring 2.

By way of representative example, referring to FIG. 22, a system utilizing two measuring springs 122 as variable inductors L1/L2, such as described herein, can include capacitors C1 and C2 as part of a modified Colpitts oscillator. R1, R4, and Q1 is the transistor network, and R1 keeps injecting current into the oscillator to keep it oscillating. C3 capacitively couples the Colpitts oscillator to the base of the transistor which drives the circuit. The output of the oscillator is a sinusoidal that can be converted to a square wave to be fed to the microcontroller unit (MCU) were frequency can be measured. In an embodiment, the sinusoidal waveform on a DC bias is fed into an inverting Schmidt trigger gate to convert it to a square wave, which conditions the signal so the timer input on the MCU can measure the frequency. In an embodiment a factory calibration of a manikin utilizing the above-described circuit can include a two-point calibration routine to reduce or remove inaccuracies due to component tolerances.

Dimensional changes in the length of coil springs in a manikin of the present disclosure can be beneficially detected to measure, record, and/or report the depth of a chest compression when pressing of the chest plate of a CPR manikin.

The dimensional change of the length of the measuring springs 122 can be determined by the LC oscillator circuit described herein. Thus, the dimensional shortening of the measuring springs 122 can be detected, measured, recorded, and/or reported as a depth of compression of the main compression spring 120 during chest compressions on a manikin, such as the manikin 100 referred to in FIG. 3, which also shows depth measure springs 122 interior to the main compression spring 120. Representative visual feedback can be in the form of an image presented to the user showing the depth of chest compressions, including under or over compression and visual indications for correction. The visual image, or data or instructions for causing the display of the visual image, can be received via wireless communication to a user's smartphone, or other device, or to a dedicated device component of the manikin such as an LCD panel and/or a plurality of LEDs designed into the manikin, as described herein. In addition to depth compression detected as length dimension changes, the LC oscillator circuit described herein additionally allows the detection of absolute depth compression of the chest compression plate 118 at varying points in time, whether the chest compression plate is in motion or not, and static position. Thus, in a training scenario, depth of compression, rate of compression, recoil, and “hands off” time can be determined, recorded, and/or reported.

In an embodiment of a manikin for measuring depth compression during chest compressions, the system can include audio and/or visual feedback to indicate a chest compression of between about 1 inches and about 3 inches, or between about 1.5 inches and about 2.5 inches, or between about 2 inches (5 cm) and about 2.5 inches (6 cm).

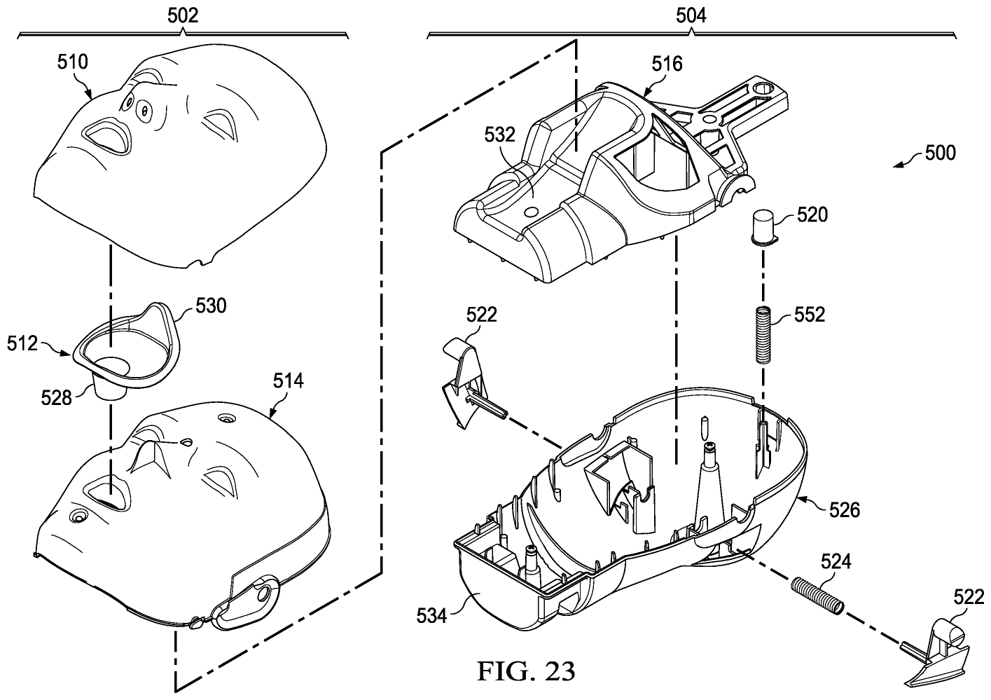

Referring now to FIG. 23, there is shown in exploded view components of a representative manikin head 500. The illustrated manikin head 500 is an adult manikin head, but the various features disclosed can be modified as desired to make various sizes and shapes of, for example, child or infant heads.

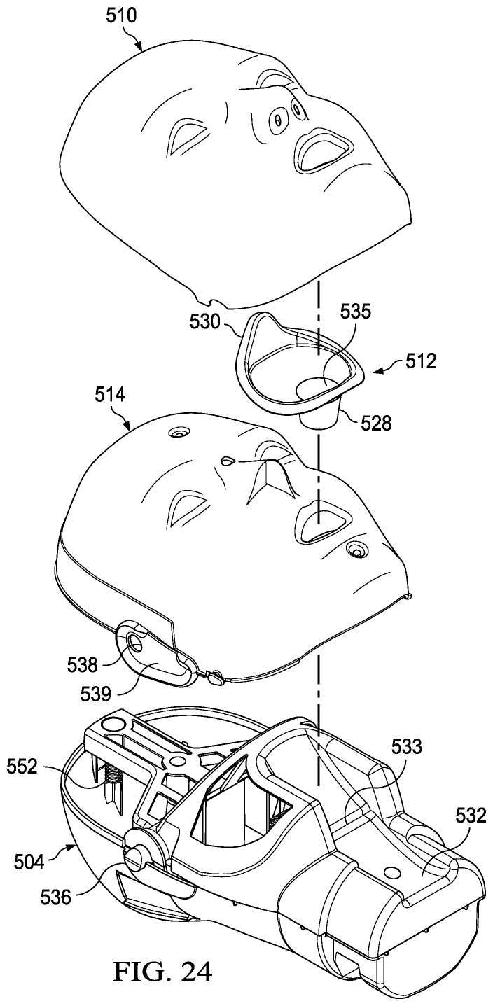

The manikin head 500 can have various layered components, each component designed for a specific function, as disclosed herein. An external face skin 510 can be an elastomeric material that mimics the look and feel of human skin. The face skin 510 can be a molded polymeric material, molded into the shape of a human face. The face skin 510 is sized and shaped to fit on a similarly sized and shaped face support 514. The face support can be relatively less flexible and less pliable than the face skin 510, thereby providing to the manikin head the feel of a human skull. An airway cup 512 can be disposed in a fitting relationship between the face skin 510 and the face support 514 to provide fluid communication from the oral and/or nasal cavities of the manikin to a lung bag, as described more fully below. The airway cup 512 can be thermoformed from a plastic sheet into a cup-like structure that fits between the face skin 510 and the face support 514 to direct air entering the nostrils and/or mouth of the manikin head 500 into a lung bag. Thus, the airway cup 512 has a mouth extension 528 that is sized to press fit, or otherwise sealingly join, the mouth opening of the face support 514 including, as described below, into the open portion of a lung bag. Likewise, the airway cup 512 has an upwardly extending nose extension 530 that is sized to press fit, or otherwise sealingly join and make sealing contact with, the interior surface of the face skin 510 at the nose area. The mouth extension 528 defines an air passage opening 535 (shown in FIG. 24) that provides for fluid communication from the nose and/or the mouth to the lung bag. The face skin 510, the face support 514, and the airway cup 512 can be assembled as a unit that can be described as the front head portion 502. The airway cup 512 can protect the front head portion, as well as all the various manikin head 500 parts, aside from the face skin 510, from being contaminated due to mouth-to-mouth or mouth-to-nostril breathing during CPR training on a manikin. The front head portion 502 can be removably detached from the rear head portion 504, as described below.

Continuing to describe the representative manikin head 500 in FIG. 23, and with reference to FIG. 24, the manikin head 500 includes a rear head portion 504 that, in general, corresponds to the back of the manikin head 500 and includes a neck portion. A rear head support 516 can be joined to a rear head outer surface 526 to form, together with other components such as springs and latches, the rear head portion 504 and the neck portion 534, as shown in more clarity in FIG. 24. The rear head support 516 can be a molded polymer component providing a relatively rigid structure to the rear head portion 504, as well as providing for latching features, spring connections, and a recessed channel 532 in which the lung bag can be positioned during use. Further, in an embodiment, at a portion of the recessed channel 532 there can be a pinch surface 533 which can be, in an example, a grooved portion of the recessed channel 532 disposed generally transverse to the direction of the recessed channel 532. The rear head outer surface 526 can be made of a relatively rigid polymer and molded to form the general shape of the rear of a human head.

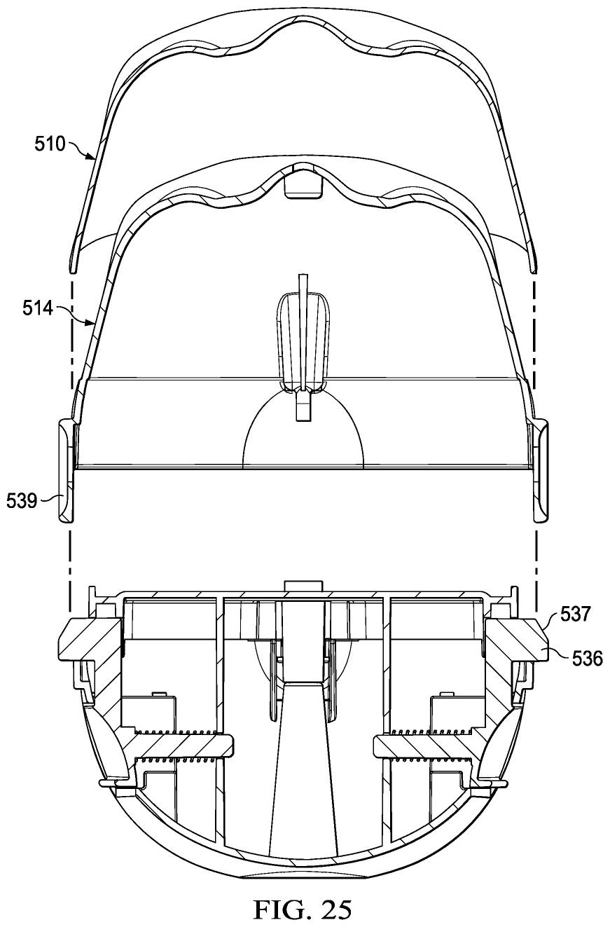

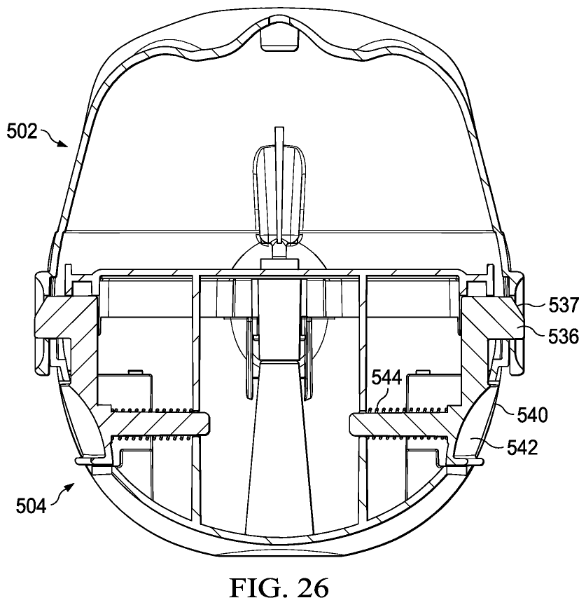

Continuing to refer to FIGS. 23 and 24, and with reference to the schematic cross-sectional views of FIGS. 25 and 26, the front head portion 502 can be pivotally joined to the rear head portion 504 about latching pins 536, which can be part of a spring loaded latching mechanism 540. The latching pins, one on each side of the rear head portion 504 in the general vicinity of the ears, can latch into corresponding latch openings 538 defined on latching member 539 in the general area of the ears on the front head portion 502, including, in an embodiment, in the face support 514 component of the front head portion 502. The latching mechanism 540 can be biased in an extended position by a latch biasing spring 544 disposed in an operationally stable position internally to the rear head portion 504. The latch biasing spring 544 urges the latching pin 536 into a latched position in which the latching pin 536 engages the corresponding latch opening 538 when the front head portion 502 is operationally connected to the rear head portion 504 as depicted in FIG. 26. To connect the front head portion 502 to the rear head portion 504, the front head portion 502 can be pressed onto the rear head portion 504 with the latching pins 536 aligned with the corresponding latch openings 538, as depicted in FIG. 25. In an embodiment, the latching pins have a tapered bearing surface 537 on which the latching member 539 can be urged to cause the latching pins to more easily and automatically depress against the force of the latch biasing spring 544. As the front head portion 502 engages the latching pins 536, the latching pins 536 can be urged inwardly against the force of the latch biasing spring 544 until they are released into the latch openings 538, at which time the front head portion 502 is secured to the rear head portion 504. To release the front head portion 502, pressure can be exerted at a finger depression 542 on which force can be directed to depress the latch biasing spring 544 until the latching pins 536 clear the latch openings 538. In this manner, the front head portion 502 can be easily removed to, for example, change out a lung bag.

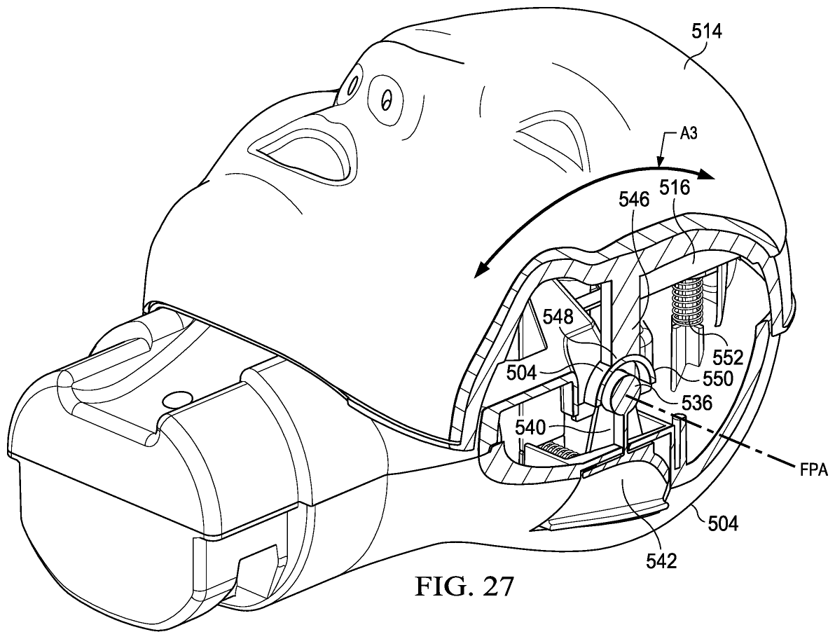

Another beneficial advantage of the above-described latching mechanism 540 is illustrated in FIG. 27, which shows the pivoting capability of the latching mechanism 540. On each side of the front head portion 502 a pivot extension 546 can extend. The proximal end of the pivot extension 546 can be joined to, or integral with, the face support 514. The distal end of the pivot extension 546 can have an arcuately shaped pivot seat 548 that slidably engages the similarly arcuately shaped pivot surface 550, which can be a molded feature on rear head support 516, or other component of the rear head portion 504. In this manner, the face support (and, in operation, the front head portion 502) can pivot about an axis general corresponding to the ear area of the head, and more particularly about an axis of the latching pins 536, as indicated by arrow A3.

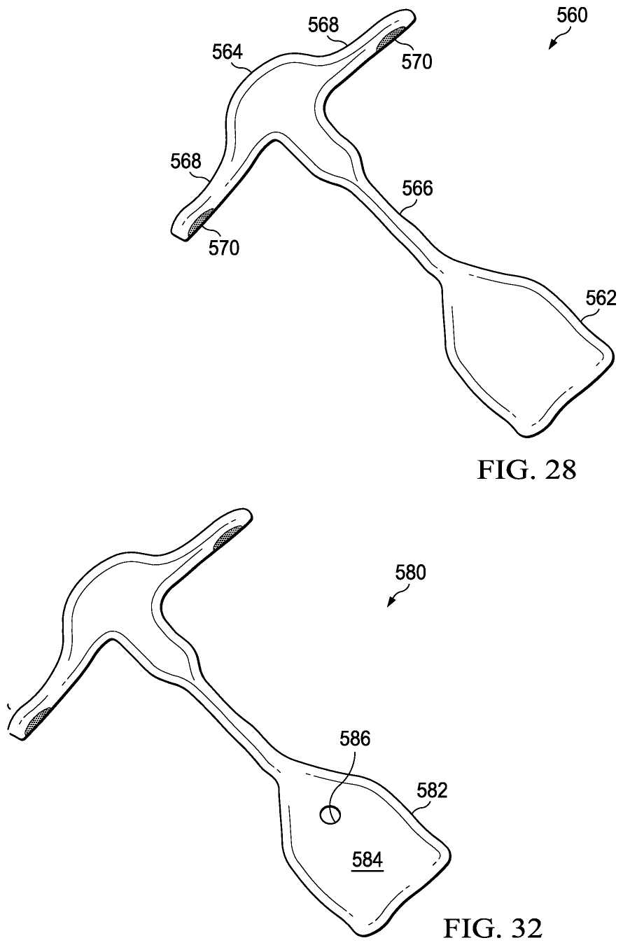

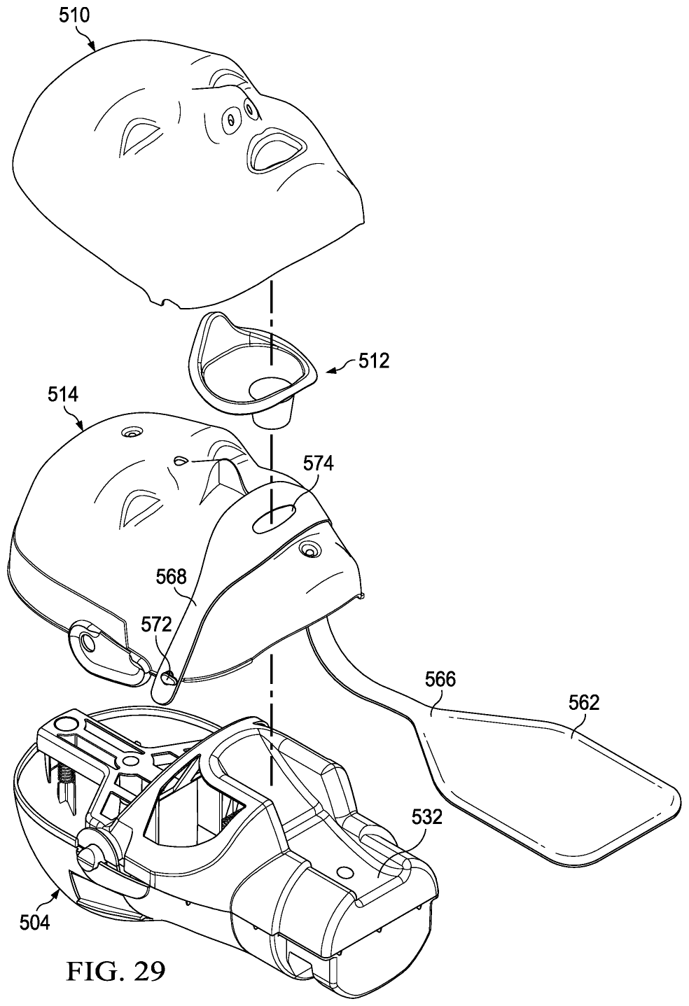

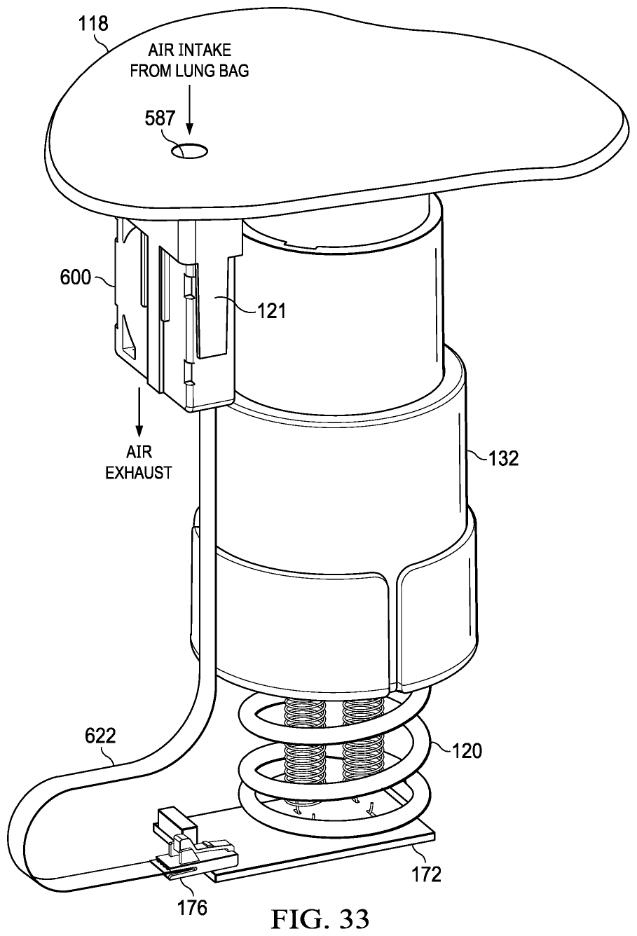

Referring now to FIGS. 28 and 29, there is shown a representative example of a lung bag 560 and a representative lung bag installation configuration. The lung bag 560 can be a flexible and/or elastomeric polymer material and simulates a human lung and encloses a volume that can receive and release breathed air during mouth-to-mouth CPR training on the manikin. The lung bag 560 can have a bladder 562 that, when operational in a manikin, can be interiorly disposed generally in the chest area of the manikin. A face connecting member 564 mechanically joins the lung bag 560 to the manikin as well as provides for air communication from the mouth of a person performing mouth-to-mouth CPR training to the bladder 562 via a lung bag opening 574 defined in the face connecting member 564. The lung bag opening 574 can be defined by an opening achieved by separating the film layers at the central portion of the face connecting member 564, for example. The face connecting member 564 is joined to the bladder 562 by a throat portion 566 that provides fluid communication from the face connecting member 564 to the bladder 562. The face connecting member 564 has two laterally extending wing members 568 that have wing connectors 570 at or near their respective distal ends. The wing connectors 570 can connect to corresponding head connectors 572 on the manikin head, for example, on the face support 514, as shown. The wing connectors 570 can be loops, tabs, hooks, and the like. The head connectors 572 can be mating elements to the wing connectors 570, including loops, tabs, hooks, protrusions, shafts, pins, and the like. In the illustrated embodiment in FIG. 33, loop wing connectors 570 are pulled down around the surface of the face support 514 and hooked onto molded tab head connectors 572. In an embodiment, the wing members 568 can be elastomerically stretched into their respective connected configurations, such that the face connecting member 564 is pressed relatively tightly to the face support 514 to provide for a substantially leak-free interface, while the lung bag opening 574 positioned over a mouth opening defined in the face support 514.

Further as depicted in FIG. 29, the lung bag 560 can be disposed though the face support 514, and the face support 514 can be joined to the rear head portion 504 as described above. The throat portion 566 of the lung bag 560 can fit into and be operationally disposed in the recessed channel 532 described above. The airway cup 512 can optionally be joined in a substantially leak-free interface to the lung bag and the face skin 510 joined to the face support 514.

In an embodiment of method, therefore, a lung bag 560 can be fit, e.g., via friction fit, over a generally tubularly-shaped mouth extension 528 of the airway cup 512. The mouth extension 528 (FIG. 24) and the lung bag 560 is then inserted into the mouth cut-out of the face support 514 until the outer perimeter of the airway cup 512 prevents any further insertion. The throat portion 566 can be laid into the recessed channel 532. The laterally extending wing members 568 can be connected to the face support 514. The face skin 510 can be attached, providing a full or partial seal between the face skin and the face support-facing portions of the airway cup 512, the full or partial seal providing a full or partial barrier against contaminated breaths from persons performing mouth-to-mouth or mouth-to-nose CPR training on a manikin.

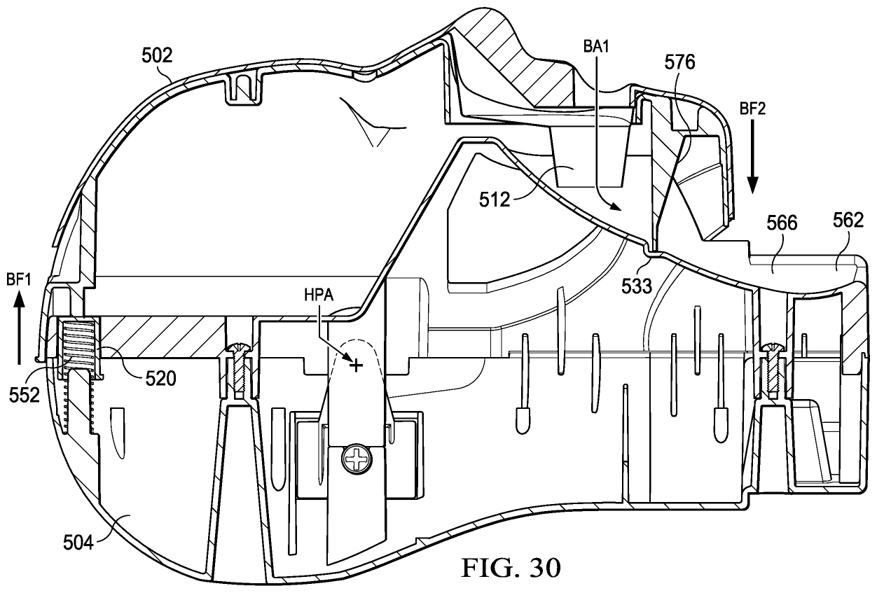

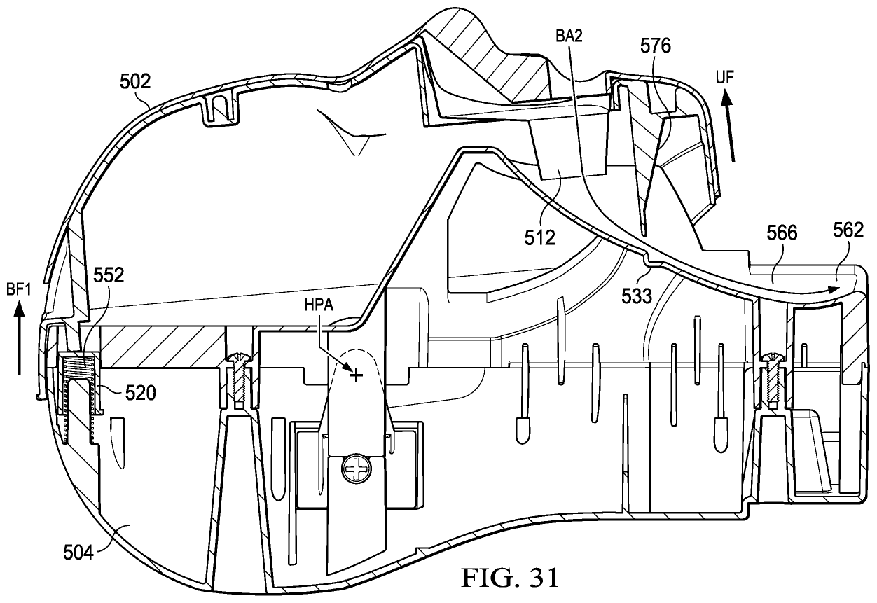

Referring back to FIGS. 23 and 27, a chin pivot spring 552 can bias the face support (and, in operation, the front head portion 502) in a “chin down” position relative to the rear head portion 504 by forcing the chin down. This is due to the face support (and, in operation, the front head portion 502) being pivotally joined to the rear head portion 504 about face pivot axis FPA general corresponding to the ear area of the head, and more particularly about an axis of the latching pins 536. This feature is disclosed further with reference to FIGS. 30 and 31 showing a manikin head 500 is illustrated in cross-sectional depiction showing certain features permitting more lifelike CPR training. The chin pivot spring 552 can be constrained by molded features of the head portion, and can be at least partially constrained in a pivot spring housing 520.

Referring to FIG. 30, the front head portion 502 in a “chin down” default position with the chin pivot spring 552 being in constrained extension forcing the chin down about the head pivot axis HPA, the constraint being the throat portion 566 of the lung bag 560 being pinched closed between an air cut off blade 576 and the pinch surface 533 of the recessed channel 532. The air cut off blade 576 can be a part of the front head portion 502 and can have a generally chisel-like distal end having a width sufficient to span the width of the throat portion 566 of the lung bag 560 such that when forced against the pinch surface 533 by the biasing force of the chin pivot spring 552 breathed air is prevented from entering the lung bag, as indicated by the arrow BA1, which stops at the air cut off blade 576. Thus, as the chin pivot spring 552 exerts a biasing force in the direction of the arrow BF1, the chin experiences a chin biasing force in the direction of arrow BF2, which in a fully biased configuration results in the air cut off blade pressing the throat portion 566 at least partially closed, and in an example, fully closed, to the passage of breathed air.

Referring now to FIG. 31, the chin portion of the manikin head is forced upwardly in the direction of the arrow UF, which can be, for example, by the hands of a person performing CPR training on a manikin. Forcing the chin upwardly causes the chin pivot spring 552 to compress and shorten while the distal end of the air cut off blade 576 moves away from the pinch surface 533, thereby permitting breathed air to pass into the lung bag, as indicated by the arrow BA2. Thus, as long as the chin is sufficiently raised against the biasing force of the chin pivot spring 552, the airway passage between the mouth or nose of the manikin, and more specifically between the airway cup 512, and the bladder of the lung bag is open for the free passage of breathed air.

The chin pivot spring 552 can be a metal coil spring. The chin pivot spring 552 can be mounted at any location in which it can bias the front head portion 502 about the head pivot axis. In an embodiment, the chin pivot spring 552 is a metal coil spring and one end of the chin pivot spring 552 is affixed over a pin protruding from a portion of the rear head portion 504 and the other end is affixed over a pin protruding from a portion of the front head portion 502. In an embodiment, the chin pivot spring can be selected from the group consisting of extension springs, compression springs, plastic springs, torsion springs, and/or constant force springs. In an embodiment, the chin pivot spring can be selected from the group of elastic bands, metal bands, and/or spring washers. In an embodiment, the chin pivot spring can be externally located relative to one or more components of the manikin head 500.

Referring now to FIGS. 33-41 there are illustrated various features and components for sensing airflow during mouth-to-mouth or mouth-to-nose CPR training on a manikin. An airflow sensor can sense the presence and volume of airflow through the lung bag 560, for example. An airflow sensor can also be configured in various places in or on the manikin, such as in the throat portion of the lung bag, but the illustrated embodiments will focus on an airflow sensor configured below the chest compression plate 118 and electrically powered by wiring connected to the PCBA 172 at a connector 176, as disclosed above with respect to FIG. 33, for example.

FIG. 32 shows a lung bag 580 that can be similar in all respects to the lung bag 560 described above. The bladder 582 of the lung bag 580, however, differs from the lung bag 560 described above in that a lower surface 584 thereof defines a bladder opening 586, such as a relatively small circular hole, through which air entering the bladder 582 can escape. The lower surface 584 of the bladder 582 lays over and interfaces with the upper surface of the chest compression plate 118, which upper surface also defines a plate opening 587. The bladder 582 is positioned in a face to face interfacing relationship with the chest compression plate 118 such that the plate opening 587 and the bladder opening 586 are aligned and permit fluid communication of air from the bladder 582 to pass through the chest compression plate 118.

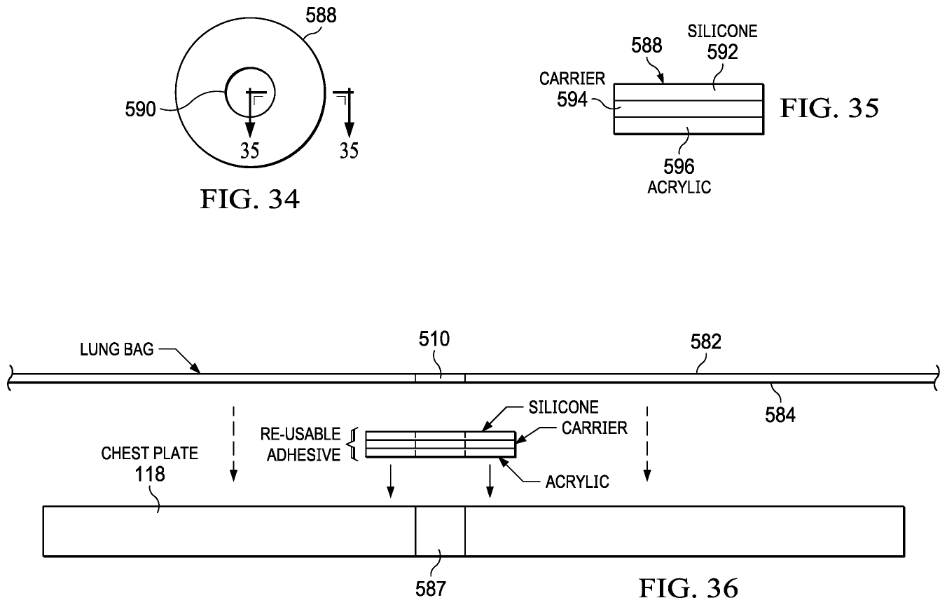

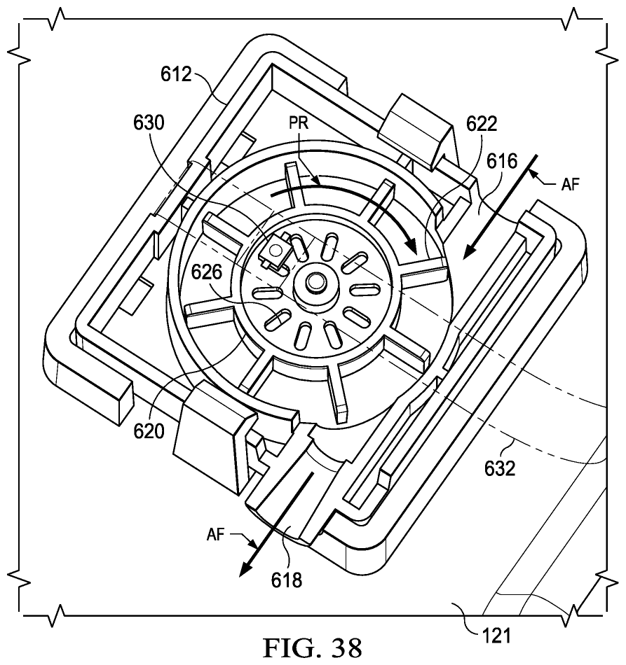

The bladder opening 586 is functionally aligned and secured to the plate opening 587 in a manner that can withstand the forces of chest compression and yet is relatively easy to remove. In an embodiment, at least a portion of the bladder 582, including around the bladder opening 586, can be joined to a portion of the chest compression plate 118, including around the plate opening 587 (also depicted in the chest compression plate 118 of the manikin 100 shown in FIG. 2). In an embodiment, joining is achieved by an adhesive. In an embodiment the adhesive is a ring of adhesive that can be adhesive on two sides, each side adhering to one of the bladder 582 and the chest compression plate 118. In an embodiment, the adhesive is a silicone/acrylic adhesive. In an embodiment, as shown in FIGS. 34-36, the adhesive is a ring of silicon/acrylic adhesive. FIG. 38 is a plan view of a bladder adhesive member 588 in the shape of a disc having a central aperture 590 defined therein. The bladder adhesive member 588 can be multi-layered, including three-layered as shown in the cross-sectional view in FIG. 36. In the illustrated example, the bladder adhesive member 588 includes a carrier 594 laminated between a silicone layer 592 and an acrylic layer 596. In use, the bladder adhesive member 588 can be provided, for example, on a roll, and used as indicated in FIG. 36. The central aperture 590 is aligned with the bladder opening 586 and the plate opening 587 between the bladder 582 and the chest compression plate 118 and pressed into a joining interface. As illustrated, the silicone layer can interface with the lung bag 580 and the acrylic layer 596 can interface with the chest compression plate 118. When sealed in proper alignment, the bladder adhesive member 588 can provide for a removable, substantially leak-free seal between the bladder 582 and the chest compression plate 118.

Referring back to FIG. 33, airflow from breathed air in the lung bag 580 can flow through the plate opening 587 and enter the inflow port of an airflow sensor 600 that can be a flow meter, including a paddle wheel flow meter. In the illustrated example, the chest compression plate 118 can have an airflow sensor mount 121 joined to, or integral with, a lower surface thereof, and spaced to clear any obstruction with the telescoping piston sleeve 132. Thus, the airflow sensor 600 moves with the movement of the chest compression plate 118 during chest compressions. A flexible power and/or data cable 632 provides electrical connection from the airflow sensor components and the connector 176 on the PCBA 172. Once air flows through the airflow sensor 600 it can be exhausted from an outflow port to the interior of the manikin 100, 200. The airflow sensor 600 can monitor breaths and display feedback to a user in the form of data related to the breaths, such as volume, breaths per minute, and the like, to a visual display. The feedback can be received via wireless communication to a user's smartphone, or other device, or to a dedicated device component of the manikin such as an LCD panel on the control device 140 and/or a plurality of LEDs designed into the manikin 100, 200.

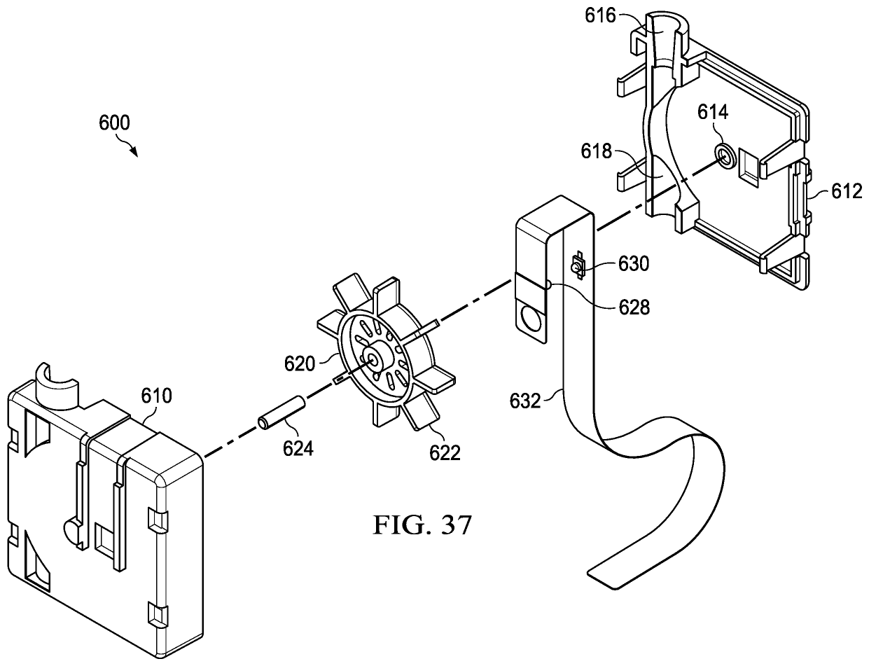

FIG. 37 shows an example configuration an airflow sensor 600 in an exploded view showing its primary components. FIG. 38 shows a cross-section of the airflow sensor 600. Certain features commonly understood, such as screw connections, connection tabs, and the like are not shown for clarity. The airflow sensor 600 includes a protective housing that can be a mating pair of housing components, such as a front housing member 610 and a rear housing member 612. The front housing member and rear housing member are molded plastic parts having molded features defining, for example, shaft bearings 614, an inflow port 616 and an outflow port 618. A paddle wheel 620 can be rotatably mounted on a shaft 624 in a position such that the paddles 622 of the paddle wheel 620 enter the path of the airflow as it flows into the airflow sensor 600 in the direction of the airflow arrows AF. In this manner, as air flows through the airflow sensor 600, the paddle wheel 620 rotates about the shaft 624 in the direction of the paddle rotation PR arrow. The speed of the paddle wheel rotation is proportional to the speed of the airflow through the airflow sensor 600.

In addition to paddles 622, the paddle wheel 620 has a plurality of apertures evenly distributed about the axis of the shaft 624. The apertures 626 permit light to transmit through the paddle wheel. An energy beam in the form of light, from transmitter 628 can be directed from one side of the paddle wheel 620 toward a receiver 630 on the other side of the paddle wheel 620. In an embodiment, the transmitter 628 is an IR diode, and the receiver 630 is an IR/photo transistor. The transmitter 628 and receiver 630 are positioned in operation alignment such that light can be transmitted through the plurality of apertures 626 as the paddle wheel 620 rotates. In this manner, the timing of intermittent received signals can be converted into a rotational speed of the paddle wheel 620, and further extrapolated to breathed air velocity, volume, rate, and the like. The transmitter 628 and the receiver 630 can be in electrical communication with each other and other manikin system components via the flexible power and/or data cable 632, which can be a polyimide cable, which provides electrical connection and data transmission from the airflow sensor components and the connector 176 on the PCBA 172.

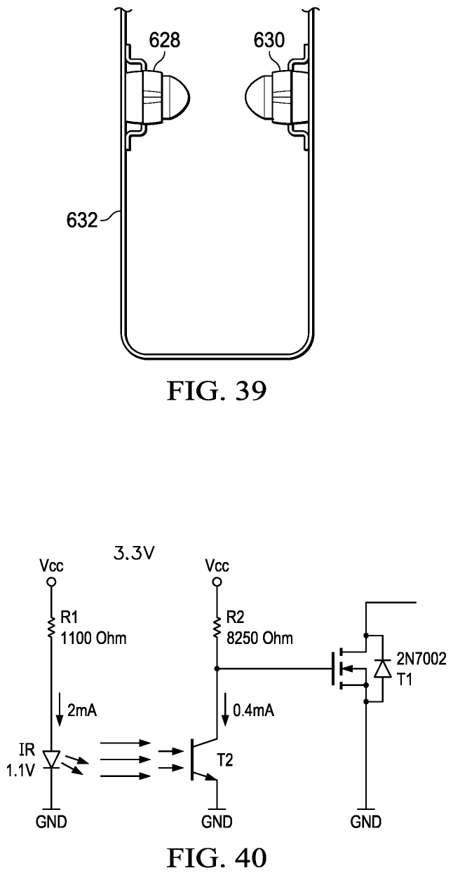

Referring to FIG. 39 there is shown a representative physical arrangement of an IR diode transmitter 628 and an IR/photo transistor receiver 630, showing one example of representative dimensions of an installed configuration. In the illustrated embodiment, the transmitter 628 and receiver 630 can have a spacing between their respective distal portions of about 3.23 mm. Thus, the width of the paddle wheel 620 utilized in the illustrated arrangement would be less than 3.23 mm. In the illustrated example, the transmitter 628 can be a VSMB2943GX01 IR diode and the receiver 630 can be a VEMT2023X01 phototransistor, both available from Vishay Intertechnology. Working dimensions different from the illustrated embodiment for all the components can be determined based on the particular hardware utilized. The transmitter and receiver can operate according to electrical circuitry designed for the particular components involved. FIG. 40 shows example circuitry for the transmitter/receiver circuit described above. In addition to the IR sensor, other technology can be employed to detect the movement or rotation of the paddle wheel feature. This technology can include, but may not be limited to, technology such as Hall sensors. Pressure sensors and other flow sensors could also be employed to detect air flow or air pressure.

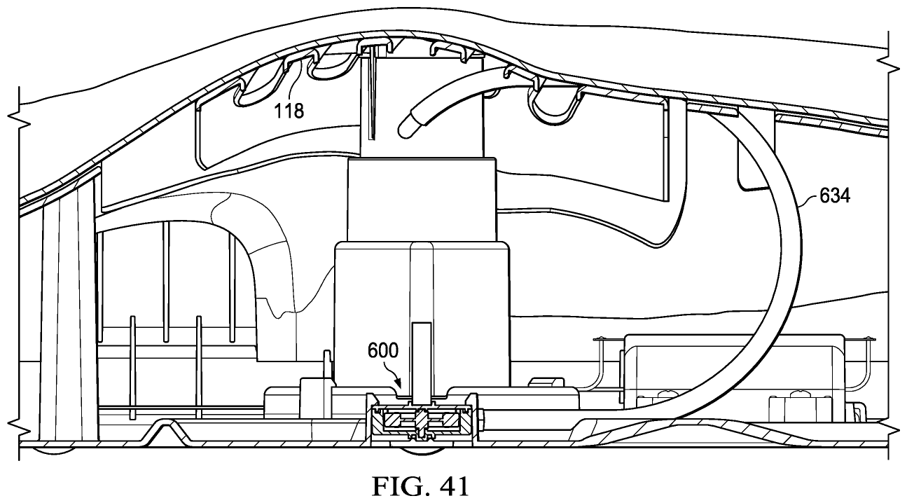

FIG. 41 illustrates another example configuration for utilizing an airflow sensor 600. In this example, the airflow sensor 600 can operate as described above. However, rather than extending from the chest compression plate 118, the airflow sensor 600 can be disposed remotely from the chest compression plate 118, such as on a lower portion of the manikin. In this embodiment, airflow passes through the chest compression plate 118, as described above, but passes into a tube 634, which can be a flexible tube, which directs the breathed air into the inflow port of the airflow sensor, as described above. In this manner, the airflow sensor 600 can be modular and can be mounted in virtually any position on or in the manikin.

As can be understood, in the illustrated embodiment of an airflow sensor 600, as the paddle wheel 620 rotates it alternately makes and breaks the electrical circuit of the IR diode transmitter 628 and the IR/photo transistor 630. This can be collected as data, for example, as logical l's and 0's in an input of a microcontroller having memory and executable instructions to determine from the data how fast the paddle wheel 620 is spinning. The microcontroller can be a dedicated processor on or in the airflow sensor 600, or it can be part of the controls of the control device 140 discussed above.

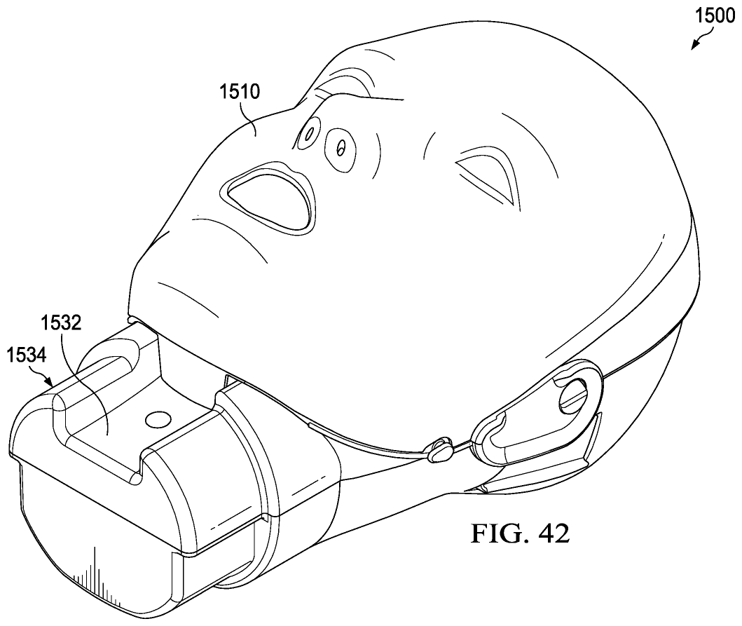

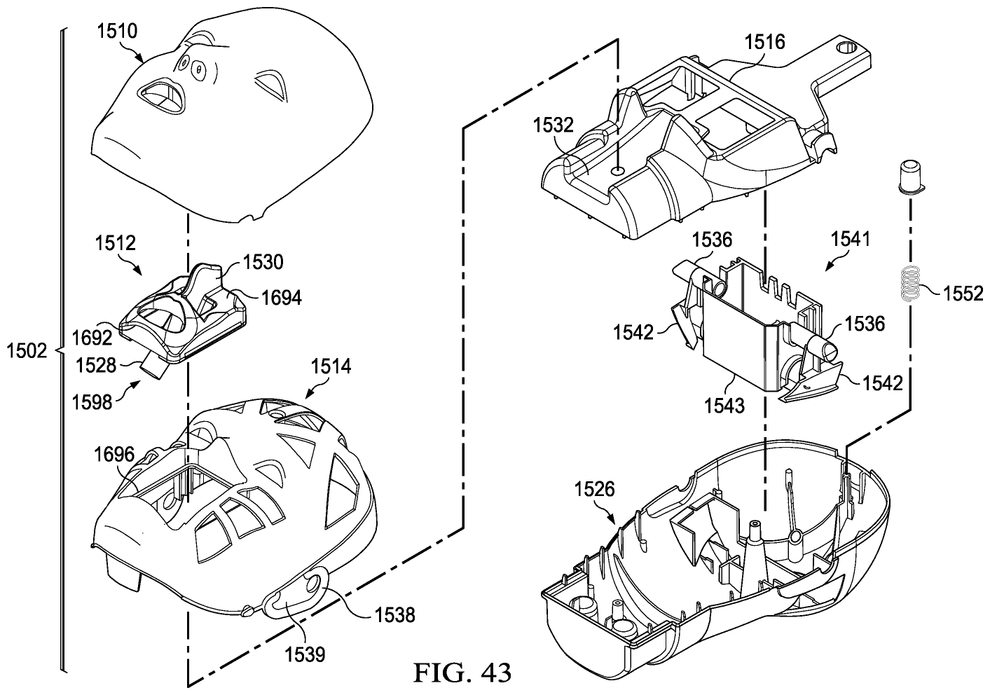

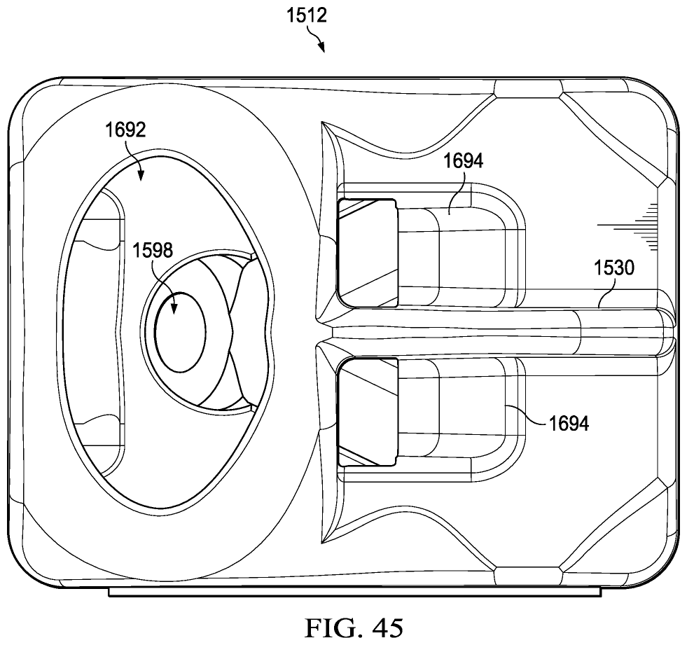

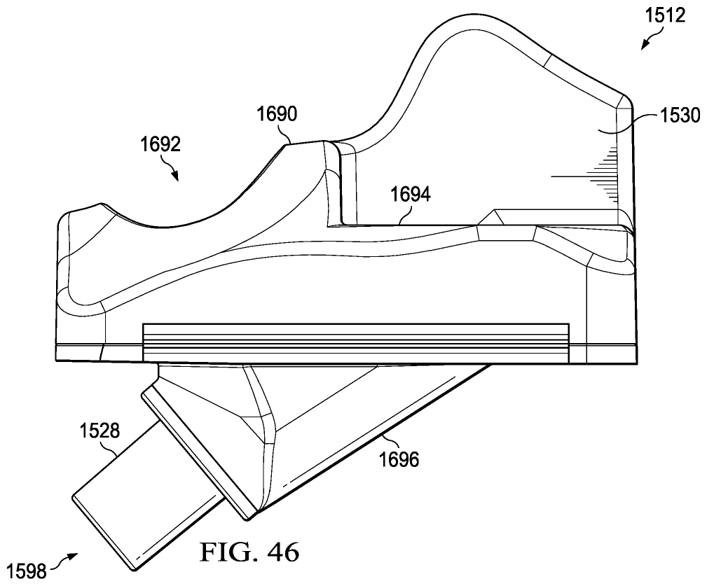

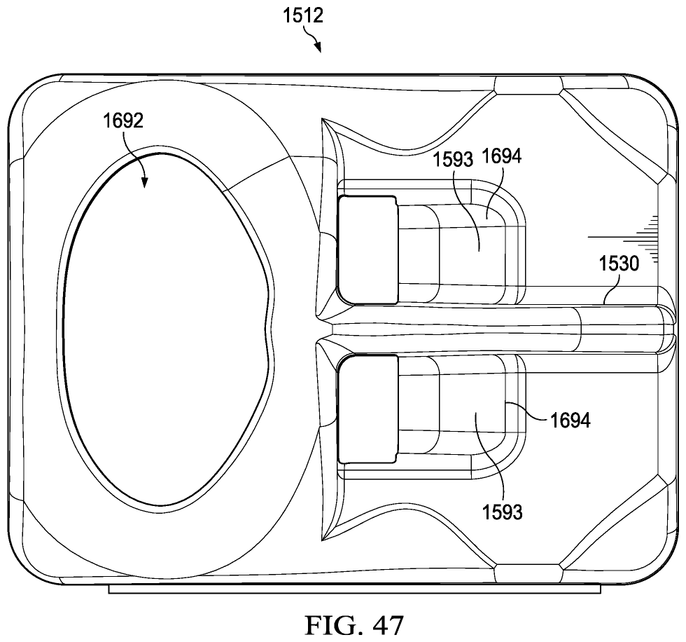

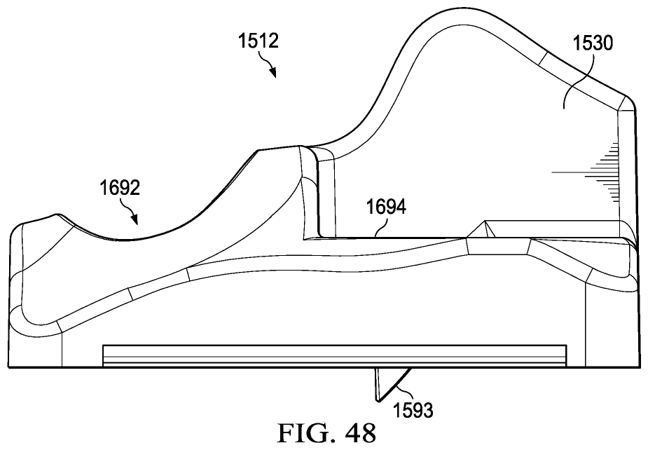

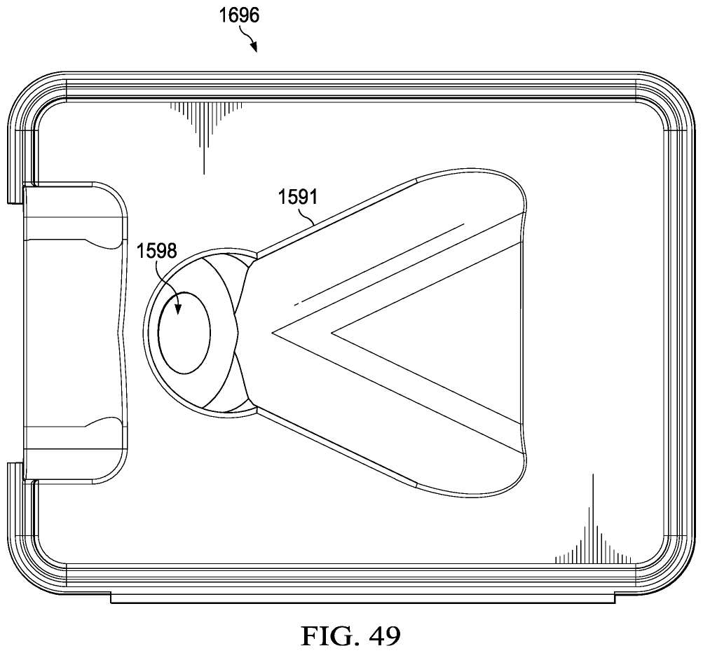

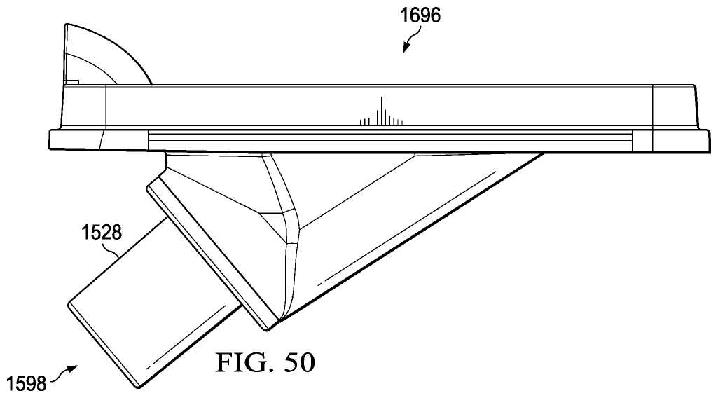

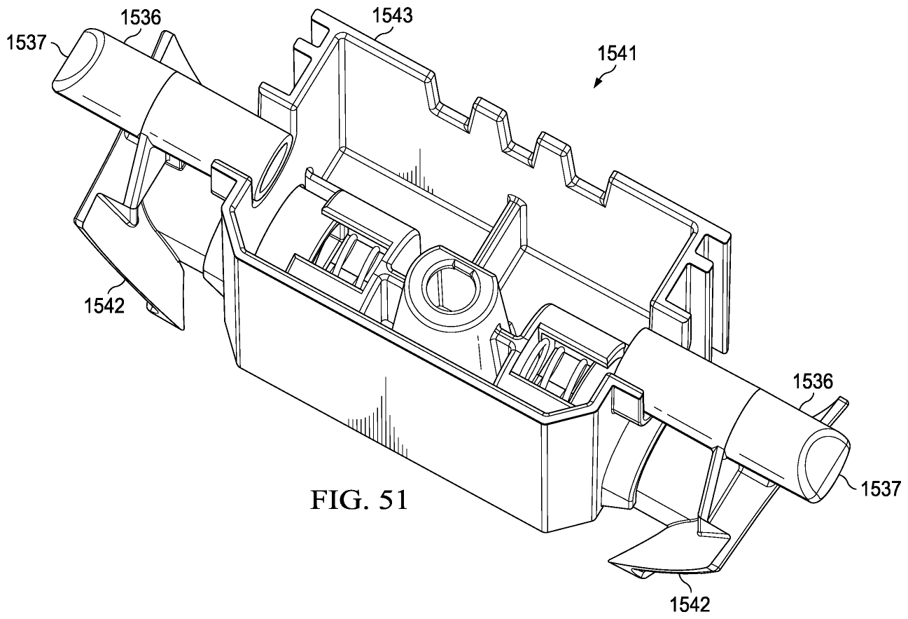

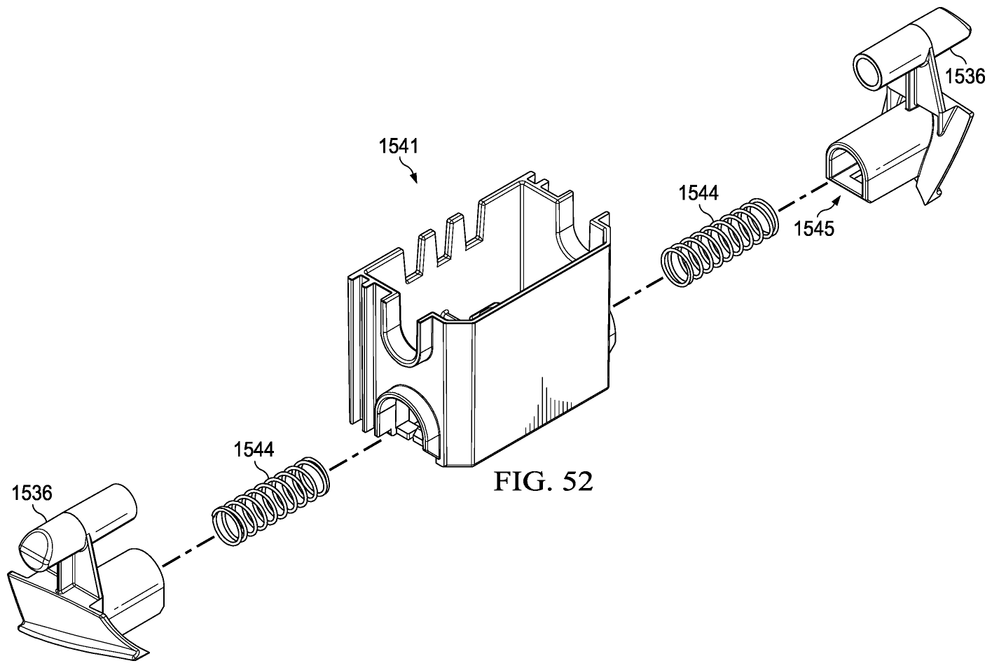

FIGS. 42-53, wherein functionally similar features are referred to with like reference numerals incremented by 1000, shows another embodiment of another embodiment of a manikin head 1500. The manikin head 1500 can include any combination of one or more features of the manikin head 500 set forth above and any one or more features set forth below with regard to manikin head 1500. The manikin head 1500 may include a rear head support 1516, a face skin 1510 connected to it and/or a face support 1514 (FIG. 43), a neck portion 1534 extended from the rear head support 1516, and a recessed channel 1532 disposed within the neck portion. Referring to the FIG. 43, there is shown in exploded view components of the representative manikin head 1500. The illustrated manikin head 1500 is an adult manikin head, but the various features disclosed can be modified as desired to make various sizes and shapes of, for example, child or infant heads.

The manikin head 1500 can have various layered components, each component designed for a specific function, as disclosed herein. The face skin 1510 can be an elastomeric material that mimics the look and feel of human skin, e.g., external skin. The face skin 1510 can be a molded polymeric material, molded into the shape of a human face. The face skin 1510 is sized and shaped to fit on a similarly sized and shaped face support 1514. The face support can be relatively less flexible and less pliable than the face skin 1510, thereby providing to the manikin head the feel of a human skull. An airway cup assembly 1512 can be disposed in a fitting relationship between the face skin 1510 and the face support 1514 to provide fluid communication from the oral and nasal cavities of the manikin to a lung bag (e.g., a lung bag 1560), as described more fully below.

The airway cup assembly 1512 can be a single or multi-component assembly. As shown in the embodiment, the airway cup assembly 1512 includes a first airway cup portion 1690 and a second airway cup portion 1696 detachably connected (e.g., snap-fit, etc.) to the first airway cup portion 1690. These two portions can also be permanently attached together (e.g., welds or other known ways of connecting two components). The first and second airway cup portions may be each be thermoformed from a plastic sheet into the structures shown in the figures such that the assembly 1512 fits at least partially within a mouth cut-out 1531 in the face support 1514 and between the face skin 1510 and the face support 1514 to direct air entering nostril openings 1506 and a mouth opening 1508 of the face skin 1510 into an opening 1561 of the lung bag 1560 (e.g., connecting the mouth and nose openings of the manikin head in fluid communication with an opening 1561 of the lung bag 1560). In some embodiments, the airway cup assembly 1512 is sized to press fit, or otherwise sealingly join to the mouth opening 1531 of the face support 1514 and to the opening 1561 of the lung bag.

The first airway cup portion 1690 includes a nose extension 1530 that in some embodiments may extend upwardly and be sized to press fit, or otherwise sealingly join and make sealing contact with, the interior surface of the face skin 1510 at the nose area. The first airway cup portion may also include first and second passageways 1694 disposed on opposite sides of the nose extension 1530. The first airway cup portion 1690 may also include a mouth passageway 1692. The second airway cup portion 1696 may include a body 1695, a passageway opening 1535 for the mouth and nose extension 1528, and a mouth and nose extension 1528 that extends from the body 1695. The opening 1561 of the lung bag is configured to fit on and/or over the mouth and nose extension 1528, and in some embodiments, sealingly fit and/or engage the mouth and nose extension 1528.

When the manikin head 1500 is assembled as shown and described herein, the nostril openings 1506 in combination with the nose extension 1530 and the first and second passageways 1694 form nostril passageways that connect the nostril openings 1506 in fluid communication with the mouth and nose extension 1528 and ultimately with the opening 1561 of the lung bag 1560. Also, when the manikin head 1500 is assembled as shown and described herein, the mouth opening 1508 in combination with the mouth passageway 1692 form a mouth passageway that connects the moth opening 1508 in fluid communication with the mouth and nose extension 1528 and ultimately with the opening 1561 of the lung bag 1560.

After use of the manikin head, the face skin 1510 and airway cup assembly 1512 may be removed from the face support 1514 and the lung bag 1560 may be removed. A sanitized (used or new) face skin 1510, airway cup assembly 1512, and lung bag 1560 can be assembled and reconnected to the face support 1514 and/or rear head portion 1504 to provide a sanitized manikin ready for use.

The face skin 1510, the face support 1514, and the airway cup assembly 1512 can be assembled as a unit that can be described as the front head portion 1502. The airway cup assembly 1512 can protect the front head portion, as well as all the various manikin head 1500 parts, aside from the face skin 1510, from being contaminated due to mouth-to-mouth or mouth-to-nostril breathing during CPR training on a manikin. The front head portion 1502 can be removably detached from the rear head portion 1504, as described below.

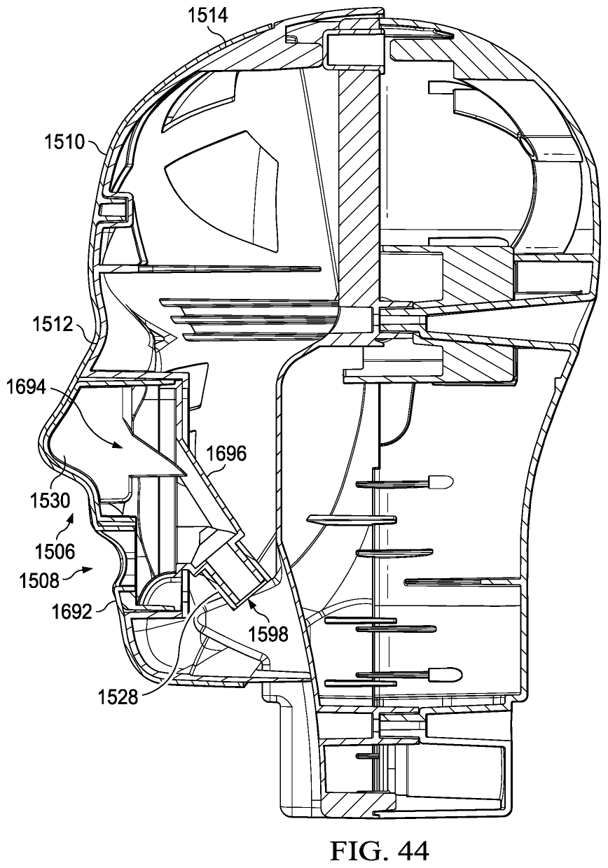

Continuing to describe the representative manikin head 1500 in FIGS. 42-53, with reference to FIG. 43, the manikin head 1500 includes the rear head portion 1504 that, in general, corresponds to the back of the manikin head 1500 and includes the neck portion 1534. A rear head support 1516 can be joined to a rear head outer surface 1526 to form, together with other components such as springs and latches, the rear head portion 1504 and the neck portion 1534, as shown in more clarity in FIGS. 43 and 44. The rear head support 1516 can be a molded polymer component providing a relatively rigid structure to the rear head portion 1504, as well as providing for latching features, spring connections, and a recessed channel 1532 in which the lung bag can be positioned during use. Further, in an embodiment, at a portion of the recessed channel 1532 there can be a pinch surface 1533 which can be, in an example, a grooved portion of the recessed channel 1532 disposed generally transverse to the direction of the recessed channel 1532. The rear head outer surface 1526 can be made of a relatively rigid polymer and molded to form the general shape of the rear of a human head.

Continuing to refer to FIGS. 43, 44, 51 and 52, the front head portion 1502 can be pivotally joined to the rear head portion 1504 about latching pins 1536, which can be part of a spring loaded latching mechanism 1540. The latching pins, one on each side of the rear head portion 1504 in the general vicinity of the ears, can latch into corresponding latch openings 1538 defined on latching member 1539 in the general area of the ears on the front head portion 1502, including, in an embodiment, in the face support 1514 component of the front head portion 1502. The latching mechanism 1540 can be biased in an extended position by a latch biasing spring 1544 disposed in an operationally stable position internally to the rear head portion 1504. The latch biasing spring 1544 urges the latching pin 1536 into a latched position in which the latching pin 1536 engages the corresponding latch opening 1538 when the front head portion 1502 is operationally connected to the rear head portion 1504 (e.g., as depicted in FIG. 26).

To connect the front head portion 1502 to the rear head portion 1504, the front head portion 1502 can be pressed onto the rear head portion 1504 with the latching pins 1536 aligned with the corresponding latch openings 1538 (e.g., as depicted in FIG. 25). In an embodiment, the latching pins have a tapered bearing surface 1537 on which the latching member 1539 can be urged to cause the latching pins to more easily and automatically depress against the force of the latch biasing spring 1544. As the front head portion 1502 engages the latching pins 1536, the latching pins 1536 can be urged inwardly against the force of the latch biasing spring 1544 until they are released into the latch openings 1538, at which time the front head portion 1502 is secured to the rear head portion 1504. To release the front head portion 1502, pressure can be exerted at a finger depression 1542 on which force can be directed to depress the latch biasing spring 1544 until the latching pins 1536 clear the latch openings 1538. In this manner, the front head portion 1502 can be easily removed to, for example, change out a lung bag.

The above-described latching mechanism 1540 (e.g., as illustrated in FIG. 27), which shows the pivoting capability of the latching mechanism 1540. On each side of the front head portion 1502 a pivot extension 1546 can extend. The proximal end of the pivot extension 1546 can be joined to, or integral with, the face support 1514. The distal end of the pivot extension 1546 can have an arcuately shaped pivot seat 1548 that slidably engages the similarly arcuately shaped pivot surface 1550, which can be a molded feature on rear head support 1516, or other component of the rear head portion 1504. In this manner, the face support (and, in operation, the front head portion 1502) can pivot about an axis general corresponding to the ear area of the head, and more particularly about an axis of the latching pins 1536, as indicated by arrow A3.

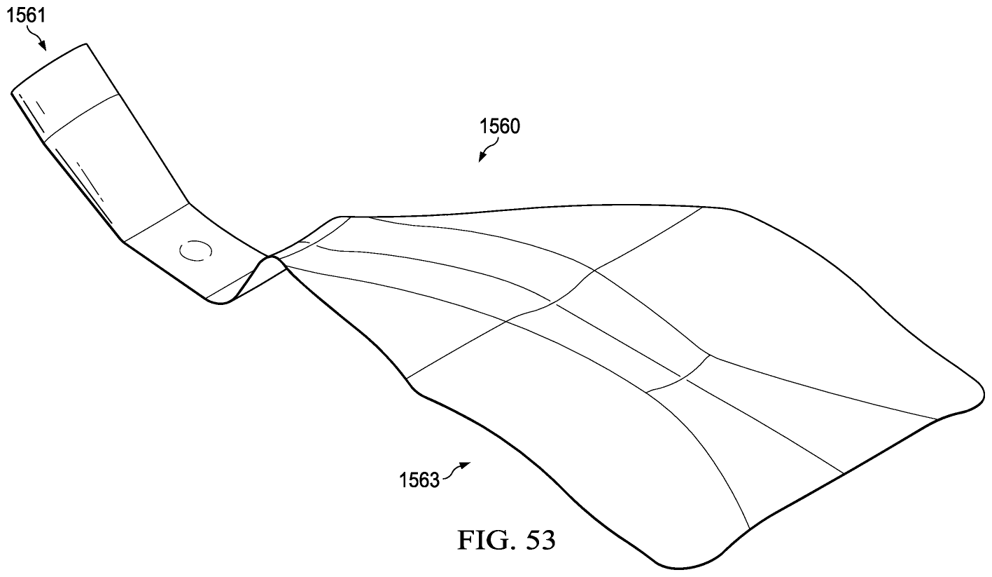

Referring now to FIG. 53, there is shown a representative example of a lung bag 1560. The lung bag 1560 can be a flexible and/or elastomeric polymer material and simulates a human lung and encloses a volume that can receive and release breathed air during mouth-to-mouth CPR training on the manikin. The lung bag 1560 can have the opening 1561 and a bladder 1562 that, when operational in a manikin, can be interiorly disposed generally in the chest area of the manikin. The opening 1561 of the lung bag 1560 can be fit, e.g., via friction fit, over the mouth and nose extension 1528 of the airway cup assembly 1512. The mouth extension 1528 and the lung bag 1560 are then inserted into the mouth cut-out 1531 of the face support 1514 until the outer perimeter of the airway cup assembly 1512 prevents any further insertion. The throat portion 1566 can be laid into the recessed channel 1532. The face skin 1510 can be attached, providing a full or partial seal between the face skin and the face support-facing portions of the airway cup assembly 1512, the full or partial seal providing a full or partial barrier against contaminated breaths from persons performing mouth-to-mouth or mouth-to-nose CPR training on a manikin.

The lung bag opening 1561 can be defined by an opening achieved by separating the film layers, for example. The opening 1561 is joined to the bladder 1562 by a throat portion 1566 that provides fluid communication between the two. The throat portion 1566 of the lung bag 1560 can fit into and be operationally disposed in the recessed channel 1532 described above. The airway cup assembly 1512 can optionally be joined in a substantially leak-free interface to the lung bag and the face skin 1510 joined to the face support 1514.

Referring back to FIG. 43, a chin pivot spring 1552 can bias the face support (and, in operation, the front head portion 1502) in a “chin down” position relative to the rear head portion 1504 by forcing the chin down. This is due to the face support (and, in operation, the front head portion 1502) being pivotally joined to the rear head portion 1504 about face pivot axis FPA general corresponding to the ear area of the head, and more particularly about an axis of the latching pins 1536. This feature is disclosed further with reference to FIGS. 30 and 31 showing a manikin head 500 (or 1500) is illustrated in cross-sectional depiction showing certain features permitting more lifelike CPR training. The chin pivot spring 552 (or 1552) can be constrained by molded features of the head portion, and can be at least partially constrained in a pivot spring housing 520 (or 1520). The manikin head 1500 can operate the same as or similar to head 500 as described above with reference to FIGS. 30 and 31.

The foregoing description of embodiments and examples has been presented for purposes of illustration and description. Although many of the illustrative embodiments shown and described above are referenced as training manikins and methods, these embodiments are not limited to training, training methods, and/or training manikins. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

What is claimed is:

1. A manikin, the manikin comprising:
a lower torso surface and an upper torso surface, the lower torso surface and the upper torso surface being joined to define a torso-shaped compartment, the torso-shaped compartment defining an interior portion and a sternum axis;
a chest compression unit disposed internally to the interior portion, the chest compression unit comprising a main compression coil spring joining in compression resistant separated positions a bottom compression plate and a chest compression plate, the main compression coil spring having a spring axis oriented generally orthogonal to and intersecting the sternum axis;
the chest compression plate residing under an interior surface of the upper torso surface and being compressible against the main compression coil spring to simulate compressions of a human chest;
at least one electrically conductive measuring spring disposed in the interior of the main compression coil spring, the at least one electrically conductive measuring spring being connected in an electrical circuit configured to measure a change in inductance with a corresponding change in a length of the at least one electrically conductive measuring spring, the electrical circuit including a printed circuit board having a CPU and a circuitry for data communication; and
an electronic device connected to the circuitry for data transmission, the electronic device having a display screen.

2. The manikin of claim 1, wherein the electronic device is directly connected to the circuitry for data communication by a wiring cable.

3. The manikin of claim 1, wherein the electronic device is indirectly connected to the circuitry for data communication.

4. The manikin of claim 1, wherein the electronic device is a smartphone and is indirectly connected to the circuitry for data communication via wireless communication.

5. The manikin of claim 1, wherein the electronic device is programmable.

6. The manikin of claim 1, wherein the chest compression plate has a size and shape that mimics a human rib cage.

7. The manikin of claim 1, wherein a plurality of LED lights are mounted on a sternum PCBA joined to the chest compression plate.

8. The manikin of claim 7, wherein the upper torso surface is translucent in a region corresponding to a placement of the plurality of LED lights.

9. The manikin of claim 7, wherein the plurality of LED lights are powered by a battery source, the battery source being disposed in the interior portion.

10. A manikin, the manikin comprising:
a lower torso surface and an upper torso surface, the lower torso surface and the upper torso surface being joined to define a torso-shaped compartment, the torso-shaped compartment defining an interior portion and a sternum axis;
a chest compression unit disposed internally to the interior portion, the chest compression unit comprising a main compression coil spring joining in compression resistant separated positions a bottom compression plate and a chest compression plate, the main compression coil spring having a spring axis oriented generally orthogonal to and intersecting the sternum axis;
the chest compression plate residing under an interior surface of the upper torso surface and being compressible against the main compression coil spring to simulate compressions of a human chest;
at least one electrically conductive measuring spring disposed in the interior of the main compression coil spring, the at least one electrically conductive measuring spring being connected in an electrical circuit configured to measure a change in inductance with a corresponding change in a length of the at least one electrically conductive measuring spring, the electrical circuit including a printed circuit board having a CPU and a circuitry for data communication;
an electronic device connected to the circuitry for data transmission, the electronic device having a display screen; and
a removable head portion joined to the torso-shaped compartment, the removable head portion including a front head portion pivotally joined to a rear head portion.

11. The manikin of claim 10, wherein the electronic device is directly connected to the circuitry for data communication by a wiring cable.

12. The manikin of claim 10, wherein the electronic device is indirectly connected to the circuitry for data communication.

13. The manikin of claim 10, wherein the electronic device is a smartphone and is indirectly connected to the circuitry for data communication via wireless communication.

14. The manikin of claim 10, wherein the electronic device is programmable.

15. A manikin, the manikin comprising:
a lower torso surface and an upper torso surface, the lower torso surface and the upper torso surface being joined to define a torso-shaped compartment, the torso-shaped compartment defining an interior portion and a sternum axis;
a chest compression unit disposed internally to the interior portion, the chest compression unit comprising a main compression coil spring joining in compression resistant separated positions a bottom compression plate and a chest compression plate, the main compression coil spring having a spring axis oriented generally orthogonal to and intersecting the sternum axis;
the chest compression plate residing under an interior surface of the upper torso surface and being compressible against the main compression coil spring to simulate compressions of a human chest, the chest compression plate including a plate opening;
at least one electrically conductive measuring spring disposed in the interior of the main compression coil spring, the at least one electrically conductive measuring spring being connected in an electrical circuit configured to measure a change in inductance with a corresponding change in a length of the at least one electrically conductive measuring spring, the electrical circuit including a printed circuit board having a CPU and a circuit for data communication;
a removable head portion joined to the torso-shaped compartment, the removable head portion including a front head portion pivotally joined to a rear head portion, the front head portion defining a open mouth member and the rear head portion being a molded polymer member defining a recessed channel;
an airflow sensor in fluid communication with the plate opening; and
a lung bag joined to the open mouth member and being partially disposed in the recessed channel, the lung bag having a bladder defining a bladder opening, the bladder opening being joined to the chest compression plate at the plate opening, there being a path for fluid communication from the open mouth member to the airflow sensor.

16. The manikin of claim 15, wherein the recessed channel includes a groove defining a pinch surface and the front head portion includes an air cut off blade positioned to engage the pinch surface.

17. The manikin of claim 15, wherein the airflow sensor includes a paddle wheel that rotates about a shaft and a plurality of apertures evenly distributed about an axis of the shaft.

18. The manikin of claim 15, wherein the chest compression plate has a size and shape that mimics a human rib cage.

19. The manikin of claim 15, wherein a plurality of LED lights are mounted on a sternum PCBA joined to the chest compression plate.

20. The manikin of claim 15, further comprising an electronic device indirectly connected to the circuit for data communication via wireless communication.
